(19) United States
(12) Patent Application Publication
(10) Pub. No.: US 2024/0070904 A1
(43) Pub. Date: Feb. 29, 2024

(54) OPTIMIZED DATA PROCESSING FOR MEDICAL IMAGE ANALYSIS

(71) Applicant: VENTANA MEDICAL SYSTEMS, INC., Tucson, AZ (US)

(72) Inventors: Karel J. Zuiderveld, Boulder, CO (US); Xingwei Wang, Sunnyvale, CA (US); Jim F. Martin, Mountain View, CA (US); Raghavan Venugopal, Fremont, CA (US); Yao Nie, Sunnyvale, CA (US); Lei Tang, Oro Valley, AZ (US)

(73) Assignee: VENTANA MEDICAL SYSTEMS, INC., Tucson, AZ (US)

(21) Appl. No.: 18/483,518

(22) Filed: Oct. 9, 2023

Related U.S. Application Data
(63) Continuation of application No. PCT/US22/24890, filed on Apr. 14, 2022.
(60) Provisional application No. 63/174,984, filed on Apr. 14, 2021.

(51) Int. Cl. G06T 7/73; G06T 7/11

(52) U.S. Cl. CPC G06T 7/73; G06T 7/11; G06T 2207/10056; G06T 2207/20021; G06T 2207/20048; G06T 2207/20156; G06T 2207/30024; G06T 2207/30204

(57) ABSTRACT

A method for analyzing an image of a tissue section may include obtaining a plurality of image locations, each corresponding to a different one of a plurality of biological structures; obtaining a plurality of locations of a first biomarker in the image; and calculating a distance transform array for at least a portion of the image that includes the plurality of seed locations. The method may include, for each of the plurality of seed locations and based on information from the first distance transform array, detecting whether the first biomarker is expressed at the seed location, and storing, to a data structure associated with the seed location, an indication of whether expression of the first biomarker at the seed location was detected. The method may include detecting, based on the stored indications, co-localization of at least two phenotypes in at least a portion of the tissue section.

### CROSS-REFERENCE TO RELATED APPLICATIONS

This patent application is a continuation of International Patent Application No. PCT/US2022/024890 filed Apr. 14, 2022, which claims priority to and the benefit of U.S. Provisional Patent Application No. 63/174,984 filed Apr. 14, 2021. Each patent application is incorporated herein by reference as if set forth in its entirety.

### FIELD

The present disclosure relates to digital pathology, and in particular to techniques for optimized data processing for medical image analysis.

### BACKGROUND

Digital pathology involves scanning of specimen slides (e.g., histopathology or cytopathology glass slides) into digital images. The tissue and/or cells within the digital images may be subsequently examined by digital pathology (DP) image analysis and/or interpreted by a pathologist for a variety of reasons including diagnosis of disease, assessment of a response to therapy, and the development of pharmacological agents to fight disease. Evaluation of tissue changes caused, for example, by disease, may be performed by examining thin tissue sections. Tissue samples may be sliced to obtain a series of sections (each section having a thickness of, e.g., 4-5 microns), and each tissue section may be stained with different stains or markers to express different characteristics of the tissue. Each section may be mounted on a slide and scanned to create a digital image for examination by a pathologist. The pathologist may review and manually annotate the digital image of the slides (e.g., tumor area, necrosis, etc.) to enable extracting meaningful quantitative measures using image analysis algorithms. Because the tissue and/or cells are virtually transparent, preparation of the pathology slides typically includes using various stain assays (e.g., immunostains) that bind selectively to tissue and/or cellular components to facilitate examination (e.g., by increasing contrast among relevant features).

One of the most common examples of stain assays is the Hematoxylin-Eosin (H&E) stain assay, which includes two stains that help identify tissue anatomy information. The Hematoxylin mainly stains the cell nuclei with a generally blue color, while the Eosin acts mainly as a cytoplasmic generally pink stain, with other structures taking on different shades, hues, and combinations of these colors. The H&E stain assay may be used to identify target substances in the tissue based on their chemical character, biological character, or pathological character. Another example of a stain assay is the Immunohistochemistry (IHC) stain assay, which involves the process of selectively identifying antigens (proteins) in cells of a tissue section by exploiting the principle of antibodies and other compounds (or substances) binding specifically to antigens in biological tissues. In some assays, the target antigen in the specimen to a stain may be referred to as a biomarker. Thereafter, digital pathology image analysis can be performed on digital images of the stained tissue and/or cells to identify and quantify staining for antigens (e.g., biomarkers indicative of tumor cells) in biological tissues.

In a multiplexed slide of a tissue specimen, different nuclei and tissue structures are simultaneously stained with specific biomarker-specific stains, which can be either chromogenic or fluorescent dyes. Each of the stains has a distinct spectral signature, in terms of spectral shape and spread. The spectral signatures of different biomarkers can be either broad or narrow spectral banded and may spectrally overlap. A slide containing a specimen (for example, an oncology specimen) that has been stained with some combination of dyes is imaged using a multi-spectral imaging system. Each channel of the resulting image corresponds to a spectral band. The multi-spectral image stack produced by the imaging system is therefore a mixture of the underlying component biomarker expressions, which, in some instances, may be co-localized. More recently, quantum dots have been widely used in immunofluorescence staining for the biomarkers of interest, due to their intense and stable fluorescence.

### SUMMARY

Apparatuses and methods for optimized data processing for medical image analysis are provided.

According to various aspects there is provided a method for analyzing an image of a tissue section that includes obtaining a plurality of image locations, each corresponding to a different one of a plurality of biological structures; obtaining a plurality of locations of a first biomarker in the image; and calculating a distance transform array for at least a portion of the image that includes the plurality of seed locations. The method may include, for each of the plurality of seed locations and based on information from the first distance transform array, detecting whether the first biomarker is expressed at the seed location, and storing, to a data structure associated with the seed location, an indication of whether expression of the first biomarker at the seed location was detected. The method may include detecting, based on the stored indications, co-localization of at least two phenotypes in at least a portion of the tissue section.

According to various aspects there is provided another method for analyzing an image of a tissue section that includes obtaining a plurality of image locations, each corresponding to a different one of a plurality of biological structures; and obtaining a first sparse binary segmentation mask that includes a first tissue region of the tissue section and excludes a second tissue region of the tissue section. The first sparse binary segmentation mask may include a plurality of pixel membership values and a plurality of micro-tile membership values and may indicate, for each of the plurality of pixels, a corresponding state of a first binary membership value. Each of the plurality of pixel membership values may correspond to a respective pixel of the plurality of pixels and indicate the state of the first binary membership value for the pixel, and each of the plurality of micro-tile membership values may correspond to a respective micro-tile of a plurality of micro-tiles of the first binary mask and indicate the state of the first binary membership value for all of the pixels within a block of the image that corresponds to the micro-tile. The method may include, for each of the plurality of seed locations, and based on information from the first sparse binary segmentation mask, determining whether the state of the first binary membership value for a pixel, among the plurality of pixels, that corresponds to the seed location is a first state or a second state, and storing, to a data structure associated with the seed location, the state of the first binary membership value of the pixel. The method may include providing analysis results, based on the stored states, that include results of calculating distances or distributions among biomarkers within cells of the first tissue region.

According to various aspects there is provided a further method for analyzing an image of a tissue section that comprises a plurality of pixels and depicts a plurality of biological structures. In some aspects, the method may include: obtaining a plurality of image locations, each of the image locations corresponding to a different one of the plurality of biological structures and indicating a location of a depiction of the biological structure within the image; and obtaining a first binary mask for the image, the first binary mask indicating, for each of the plurality of pixels of the image, a corresponding state of a first binary membership value. The first binary mask may include a plurality of pixel membership values and a plurality of micro-tile membership values, each of the plurality of pixel membership values corresponding to a different one of the plurality of pixels and indicating the state of the first binary membership value for the pixel, and each of the plurality of micro-tile membership values corresponding to a different one of the plurality of micro-tiles and indicating the state of the first binary membership value for all of the pixels within a block of the image that corresponds to the micro-tile. In some aspects, the method further includes, for each of the plurality of image locations and based on information from the first binary mask, storing the state of the first binary membership value of a pixel that corresponds to the image location to a data structure that is associated with the image location.

In some aspects, for each of the plurality of image locations, the data structure associated with the image location may include a first binary marker value that indicates a positivity state of a first biomarker at the corresponding biological structure.

The method may further include obtaining a second binary mask for the image, the second binary mask indicating, for each of the plurality of pixels, a corresponding state of a second binary membership value. The second binary mask may include a plurality of pixel membership values and a plurality of micro-tile membership values, each of the plurality of pixel membership values corresponding to a different one of the plurality of pixels and indicating the state of the second binary membership value for the pixel, and each of the plurality of micro-tile membership values corresponding to a different one of the plurality of micro-tiles and indicating the state of the second binary membership value for all of the pixels within a block of the image that corresponds to the micro-tile. In some aspects, the method further includes, for each of the plurality of image locations and based on information from the second binary mask, storing the state of the second binary membership value of a pixel that corresponds to the image location to the data structure that is associated with the image location.

The method may further include, for at least a portion of the image, calculating a distance transform array, wherein each value of the distance transform array corresponds to a different respective pixel of the image and indicates a distance between the pixel and a closest among the plurality of image locations for which the first binary marker value indicates a first positivity state.

In some aspects, for each of the plurality of image locations, the data structure associated with the image location may include a second binary marker value that indicates a positivity state of a second biomarker at the corresponding biological structure.

The method may further include storing values of the distance transform array that correspond to image locations for which the second binary marker value indicates a first positivity state. The method may yet further include sorting the stored values in order of magnitude.

In some aspects, for each of the plurality of image locations, the data structure associated with the image location may include a first binary marker value that indicates a positivity state of a first biomarker at the corresponding biological structure. In such case, the method may further include, for each of a plurality of overlapping tiles of the image, calculating a distance transform array that includes, for each pixel of the tile, a corresponding value that indicates a distance between the pixel and a closest among the plurality of image locations for which the first binary marker value indicates a first positivity state.

In some aspects, for each of the plurality of image locations, the data structure associated with the image location may include a second binary marker value that indicates a positivity state of a second biomarker at the corresponding biological structure, and each of the plurality of tiles may include an inner region that does not overlap the inner region of any other tile among the plurality of tiles. In such case, the method may further include, for each of the inner regions, storing values of the distance transform array of the corresponding tile that correspond to image locations for which the second binary marker value indicates a first positivity state.

In any of the various aspects of the method as, for example, set forth above, each of the plurality of biological structures may be a cell nucleus. Additionally or alternatively, the image may be a multiplexed immunofluorescence image having a plurality of channels.

According to various aspects there is provided a non-transitory computer readable medium. In some aspects, the non-transitory computer readable medium may include instructions for causing one or more processors to perform operations for analyzing an image of a tissue section that comprises a plurality of pixels and depicts a plurality of biological structures, including: obtaining a plurality of image locations, each of the image locations corresponding to a different one of the plurality of biological structures and indicating a location of a depiction of the biological structure within the image; and obtaining a first binary mask for the image, the first binary mask indicating, for each of the plurality of pixels of the image, a corresponding state of a first binary membership value. The first binary mask may include a plurality of pixel membership values and a plurality of micro-tile membership values, each of the plurality of pixel membership values corresponding to a different one of the plurality of pixels and indicating the state of the first binary membership value for the pixel, and each of the plurality of micro-tile membership values corresponding to a different one of the plurality of micro-tiles and indicating the state of the first binary membership value for all of the pixels within a block of the image that corresponds to the micro-tile. In some aspects, the method further includes, for each of the plurality of image locations and based on information from the first binary mask, storing the state of the first binary membership value of a pixel that corresponds to the image location to a data structure that is associated with the image location.

In some aspects, for each of the plurality of image locations, the data structure associated with the image location may include a first binary marker value that indicates a positivity state of a first biomarker at the corresponding biological structure.

The non-transitory computer readable medium may further include instructions for causing one or more processors to perform operations including obtaining a second binary mask for the image, the second binary mask indicating, for each of the plurality of pixels, a corresponding state of a second binary membership value. The second binary mask may include a plurality of pixel membership values and a plurality of micro-tile membership values, each of the plurality of pixel membership values corresponding to a different one of the plurality of pixels and indicating the state of the second binary membership value for the pixel, and each of the plurality of micro-tile membership values corresponding to a different one of the plurality of micro-tiles and indicating the state of the second binary membership value for all of the pixels within a block of the image that corresponds to the micro-tile. In some aspects, the operations further include, for each of the plurality of image locations and based on information from the second binary mask, storing the state of the second binary membership value of a pixel that corresponds to the image location to the data structure that is associated with the image location.

The non-transitory computer readable medium may further include instructions for causing one or more processors to perform operations including, for at least a portion of the image, calculating a distance transform array, wherein each value of the distance transform array corresponds to a different respective pixel of the image and indicates a distance between the pixel and a closest among the plurality of image locations for which the first binary marker value indicates a first positivity state.

In some aspects, for each of the plurality of image locations, the data structure associated with the image location may include a second binary marker value that indicates a positivity state of a second biomarker at the corresponding biological structure.

The non-transitory computer readable medium may further include instructions for causing one or more processors to perform operations including storing values of the distance transform array that correspond to image locations for which the second binary marker value indicates a first positivity state. The operations may yet further include sorting the stored values in order of magnitude.

In some aspects, for each of the plurality of image locations, the data structure associated with the image location may include a first binary marker value that indicates a positivity state of a first biomarker at the corresponding biological structure. In such case, the operations may further include, for each of a plurality of overlapping tiles of the image, calculating a distance transform array that includes, for each pixel of the tile, a corresponding value that indicates a distance between the pixel and a closest among the plurality of image locations for which the first binary marker value indicates a first positivity state.

In some aspects, for each of the plurality of image locations, the data structure associated with the image location may include a second binary marker value that indicates a positivity state of a second biomarker at the corresponding biological structure, and each of the plurality of tiles may include an inner region that does not overlap the inner region of any other tile among the plurality of tiles. In such case, the operations may further include, for each of the inner regions, storing values of the distance transform array of the corresponding tile that correspond to image locations for which the second binary marker value indicates a first positivity state.

In any of the various aspects of the non-transitory computer readable medium as, for example, set forth above, each of the plurality of biological structures may be a cell nucleus. Additionally or alternatively, the image may be a multiplexed immunofluorescence image having a plurality of channels.

Numerous benefits are achieved by way of the various embodiments over conventional techniques. For example, the various embodiments provide methods and systems that can be used effectively obtain data from large DP images (e.g., MPX images) and quickly process statistical analysis and calculations in and among such images. In some embodiments, a sparse segmentation mask allows for fast and accurate association of image locations with corresponding tissue types. In some embodiments, a two-level tile architecture supports multithreaded processing. In some embodiments, a bitmap data structure supports compression of relevant data for rapid (e.g., interactive) statistical and/or spatial analysis. In some embodiments, distance transform calculation over overlapping image regions supports efficient calculation of distances and distributions. These and other embodiments along with many of its advantages and features are described in more detail in conjunction with the text below and attached figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1 shows an example of a multiplexed immunofluorescence (MPX) image;

FIG. 2A shows another example of an MPX image;

FIGS. 2B and 2C show a portion of the MPX image of FIG. 2A;

FIG. 3A shows an example of a result tile divided into compute tiles according to some aspects of the present disclosure;

FIG. 3B shows the example of FIG. 3A in which a tile and an inner region of a tile are shaded;

FIG. 4 shows a grid dividing a portion of an image into result tiles according to some aspects of the present disclosure;

FIG. 5 shows an example of a compute tile according to some aspects of the present disclosure;

FIG. 6A shows another example of a compute tile of an MPX image according to some aspects of the present disclosure;

FIG. 6B shows a compute tile of an epitumor binary mask that corresponds to the compute tile of FIG. 6A;

FIG. 6C shows a compute tile of a stroma binary mask that corresponds to the compute tile of FIG. 6A;

FIG. 7A shows an example of an epitumor binary mask integrated over a result tile according to some aspects of the present disclosure;

FIG. 7B shows an example of a stroma binary mask integrated over a result tile according to some aspects of the present disclosure;

FIG. 8 shows a division of a binary mask into cells and micro-tiles according to some aspects of the present disclosure;

FIG. 9 shows a classification of the micro-tiles of FIG. 8 into three classes according to some aspects of the present disclosure;

FIG. 10A shows a bitmap data structure according to some aspects of the present disclosure;

FIG. 10B shows an indexing of multiple phenotypes according to some aspects of the present disclosure;

FIG. 11A is an illustration of distances between occurrences of different phenotypes in a portion of an MPX image;

FIG. 11B is a flowchart illustrating an example of a method for computing distances between locations of a medical image according to some aspects of the present disclosure;

FIGS. 12 and 13 illustrate applications of a method for computing distances between locations of a medical image according to some aspects of the present disclosure;

FIG. 14 is a flowchart illustrating an example of a method for image analysis according to some aspects of the present disclosure;

FIG. 15A is a flowchart illustrating another example of a method for image analysis according to some aspects of the present disclosure;

FIG. 15B is a flowchart illustrating a further example of a method for image analysis according to some aspects of the present disclosure;

FIG. 16 is a flowchart illustrating a further example of a method for image analysis according to some aspects of the present disclosure;

FIG. 17 is a flowchart illustrating a further example of a method for image analysis according to some aspects of the present disclosure;

FIG. 18 is a block diagram of an example computing environment with an example computing device suitable for use in some example implementations;

FIG. 19 shows an example of an annotated MPX image, and FIGS. 20 and 21 show examples of corresponding analysis results that may be obtained from such an image according to some aspects of the present disclosure; and

FIG. 22 shows an example of another annotated MPX image, and FIGS. 23 and 24 show examples of corresponding analysis results that may be obtained from such an image according to some aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### I. Overview

The ability to characterize multiple biomarkers in tissue (e.g., in tumor tissue), and to measure heterogeneity of the presence and levels of such biomarkers within and between tissues, may provide important information for understanding and characterizing a variety of disease states and/or for the appropriate selection of available targeted therapeutics to a patient's disease state. The ability to discern and measure the areas in tissue that have different distributions of key biomarkers may provide important information to inform development of targeted and combination therapies. Development and selection of appropriate combination therapies may also be an important factor in preventing relapse.

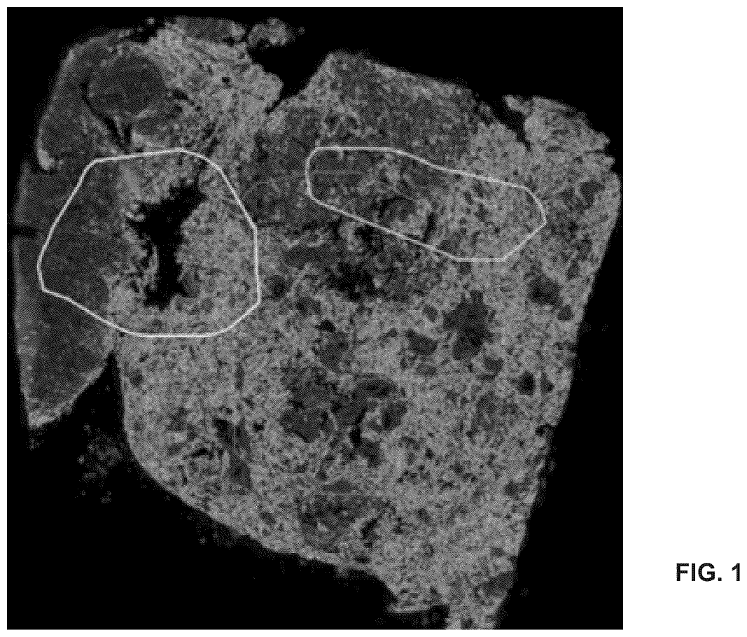

A multiplexed immunofluorescence (MPX) image of a tissue section may be obtained by staining the section with two or more fluorophores that, upon excitation (e.g., by ultraviolet light), emit light at different respective wavelengths. Each channel of the resulting image may be obtained by controlling the excitation light (e.g., selecting an excitation laser of an appropriate wavelength) to produce a desired emission profile of the target fluorophore and filtering the emitted light to block unwanted spectral components. MPX staining of tissue sections allows simultaneous detection of multiple biomarkers and their co-expression at the individual cell level. FIG. 1 shows an example of a pseudocolor version of a multiplexed immunofluorescence (MPX) image in which a corresponding pseudocolor (e.g., pink, blue, green) is assigned to each of the different channels of the MPX image. This image also includes three manual annotations of regions of interest (as indicated by the red, white, and yellow closed curves (in color) or by the three overlapping drawn closed curves at the left, center, and upper right of the image (in grayscale)). A pathologist may manually annotate an MPX image to identify, for example, which part of the tissue (e.g., tumor regions, necrotic regions, etc.) to be analyzed using image analysis and/or which regions to exclude from the image analysis.

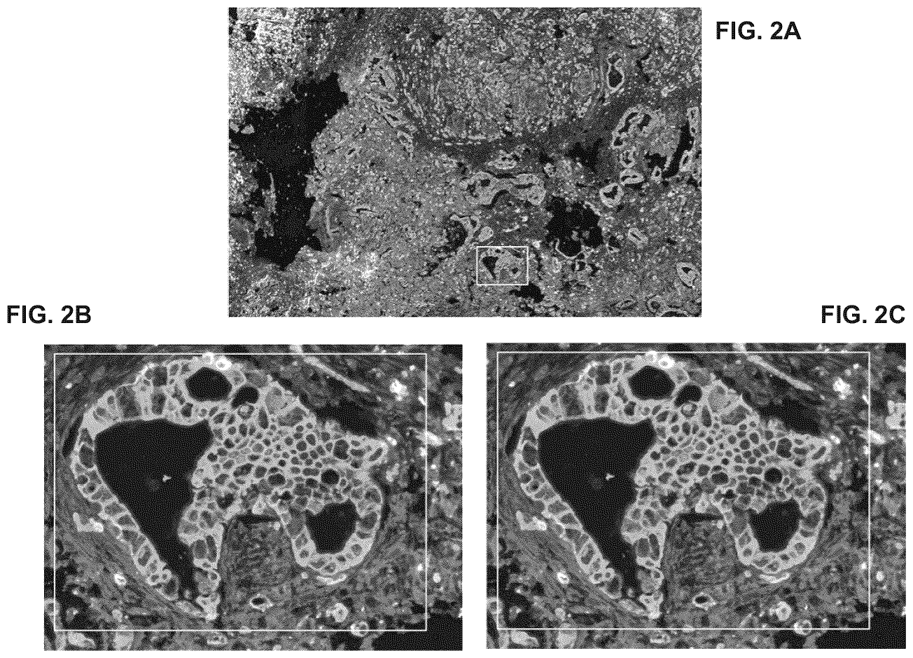

A primary analysis of an MPX image may include detection of biomarkers and phenotypes (e.g., co-expression of a particular combination of biomarkers), segmentation of the image into different tissue classes (such as, for example, epitumor (i.e., tumor epithelium), stroma (e.g., connective, supportive, or other non-functional tissue of an organ), etc.), and/or extraction of features that might be relevant (such as, for example, locations of cells (e.g., of cell nuclei)). Such analysis may be performed manually but more typically is performed using an automated process such as computer vision, machine learning, and/or deep learning. FIG. 2A shows another example of an MPX image, and FIGS. 2B and 2C show a portion of the MPX image of FIG. 2A in which computed epitumor include and exclude regions are indicated by a set of polygons (marked by a blue contour (in color) or indicated by the bright central region (in grayscale) in FIG. 2B), and detected PanCK-positive (PanCK+) cells are indicated by red dots (in color) or gray dots (in grayscale) (e.g., within the central region in FIG. 2C). Such computed polygon segmentations are typically stored as matrix arrays in a storage device such as primary or secondary memory.

A secondary analysis of an MPX image may use results from the primary analysis to obtain next-level information, for example: the density distribution of one or more biomarkers; spatial relationships between biomarkers; colocalization of multiple phenotypes in the tumor, epithelium tumor, and/or stroma; and/or other statistics and/or metrics. Such “readout analyses” may be important for a pharmaceutical company to correlate with other genome sequencing discoveries and/or molecular features and may help to determine a patient's treatment response and/or prognosis for drug development. A comprehensive automated readout statistical analysis may include one or more (possibly all) of the following: density of different cell phenotypes in regions of interest (ROIs) (e.g., “Tumor”); distances between different phenotypes in ROIs; distances from various cell phenotype to various biomarker-positive regions in ROIs; descriptive statistics/metrics for biomarker-positive regions, such as vessels; descriptive statistics/metrics for different cell phenotypes within specific distances from ROIs (e.g., immune cells, CD8); descriptive statistics/metrics for different biomarker-positive regions (e.g., fibroblast-activation-protein-positive (FAP+) regions) within specific distances from ROIs; descriptive statistics of intensity-based metrics for different biomarkers (e.g., cell-based and/or region-based); computation and representation of computed ROIs such as epithelial and stromal part of tumor, as represented by the presence or absence of the tumor marker.

An MPX image typically has about six channels and may even have as many as 32 or 64 channels or more. Additionally, the pixel values for each channel of an MPX image may have as many as 16 bits of resolution or more (e.g., as compared to the eight bits of resolution for each of the three channels of a typical RGB image). The size of a MPX whole-slide image (WSI) may be on the order of 100,000 pixels wide by 100,000 pixels high, so that the total storage size of an MPX image may be five or ten gigabytes or more.

During processing of such a large image, it is impractical to retain even a mask of the image in working memory. For an MPX image as shown in FIG. 1, it may also be impractical even to save a pixel-level mask that indicates all of the detected epitumor and stroma segmentations (e.g., as shown in FIG. 2B) in the whole slide. It is typical instead to save only the polygons which describe the segmentation (e.g., for use in future statistical analyses). During such analysis, it is typical that only a subset of the polygon segmentation is resident in memory at any one time (e.g., the subset that corresponds to the tile or other region of the image currently being analyzed). Factors such as a lack of ready access to segmentation information at the pixel level may cause an automated readout analysis for a large tissue section or for multiple tissue blocks to take a few hours (even a few days). The time currently needed to generate statistical analysis reports on large MPX images may thus fail to meet project requirements, especially for large-scale clinical trials. Moreover, such fragmentation of a polygon segmentation makes it difficult to track the different layers of the segmentation to determine which areas are excluded and included, which may affect the accuracy of the statistical calculation of biomarkers for these layers.

Techniques as disclosed herein may be used, for example, to design an effective readout analysis system to effectively fetch MPX data, efficiently process a whole slide image analysis, and/or perform corresponding statistical analysis. Such a system may effectively obtain data from large MPX images and quickly process statistical analysis and calculations in and among such images, especially for large-scale clinical trials and/or to meet the needs of pharmaceutical customers. For example, such a system may include an optimized efficient data structure and architecture design to meet the computational complexity and big data processing requirements in MPX images. Although problems as described herein may be compounded with dark-field images (e.g., MPX images), which may have a much larger number of channels (e.g., up to 32 or even 64), these techniques may also be applied to processing and analysis of DP images (e.g., whole-slide images) in general, including bright-field images (e.g., light microscopy images).

### II. Definitions

As used herein, when an action is “based on” something, this means the action is based at least in part on at least a part of the something.

As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, the term “biological material or structure” refers to natural materials or structures that comprise a whole or a part of a living structure (e.g., a cell nucleus, a cell membrane, cytoplasm, a chromosome, DNA, a cell, a cluster of cells, or the like).

### III. Techniques for Optimized Storage and Processing for Medical Image Analysis

Because of the large size of a typical DP image, it may be desired to perform an image analysis by dividing the image to be analyzed into smaller (typically square) portions of equal size called “tiles,” which are then processed individually. For MPX analysis, even better performance may be obtained by using different tile sizes for different stages of the analysis. In one such example, a two-level tile architecture includes large tiles (also called “result tiles”) and smaller tiles (also called “computational tiles” or “compute tiles”). In such a design, a division of the whole slide image (or desired region thereof) into large tiles may be applied to efficiently fetch the image data into working memory (e.g., from disk). Each large tile may then be divided into smaller tiles for use (e.g., by computer vision/deep learning/machine learning algorithms) during primary analysis, which may include operations such as phenotype/biomarker detection and/or feature extractions. Finally, the large tiles may be used to integrate results that have been computed using the smaller “compute” tiles (e.g., region masks, phenotype locations).

Potential advantages of such a two-level design may include efficient data fetching due to fewer transactions with an image server (e.g., because larger tiles are being read). In addition, smaller tiles are typically more suitable as input to deep learning/machine learning/computer vision algorithms that perform image analysis for segmentation and detection. Using smaller tiles during computation may also promote improved usage of processor (e.g., CPU and/or GPU) resources, such as cache.

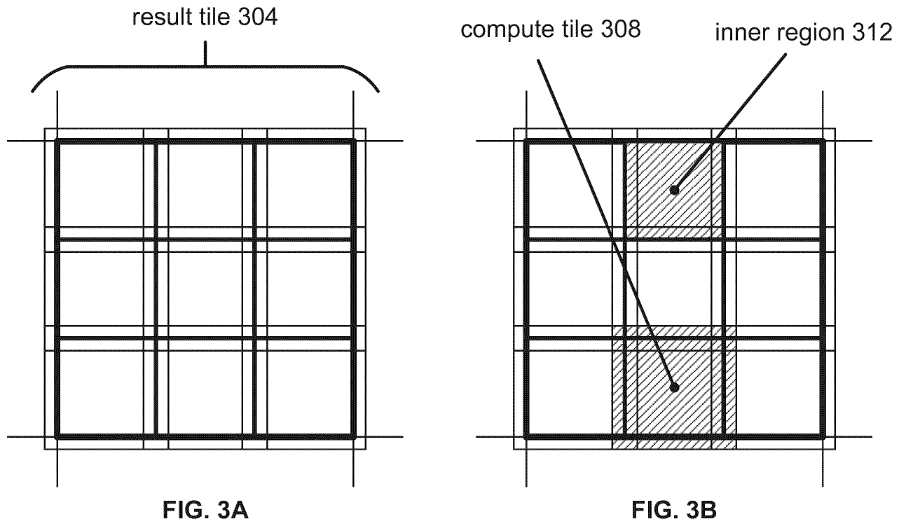

FIGS. 3A and 3B show an example of a two-level tile architecture, in which an image is divided into result tiles which are further divided into compute tiles. FIG. 3A shows an example of a result tile 304 (indicated by the outer thin square) that is divided into an overlapping 3×3 array of compute tiles of equal size. The size of each compute tile may be, for example, 128×128 pixels, 256×256 pixels, or 512×512 pixels (without limitation), with the size of each result tile being roughly three times larger in each dimension (e.g., depending on the size of the overlap). For compute tiles of size 512×512 pixels, the size of each result tile is about 2K×2K pixels.

As shown by the thin lines in FIGS. 3A and 3B, each result tile overlaps its neighbor result tiles in the image, and each compute tile overlaps its neighbors in the result tile as well. Such an overlap allows for effective handling of boundary conditions between different tiles (e.g., as described herein with reference to distance calculations). It may be desired to implement the overlap to be at least equal to a maximum distance to be computed (e.g., 100 microns, 500 microns).

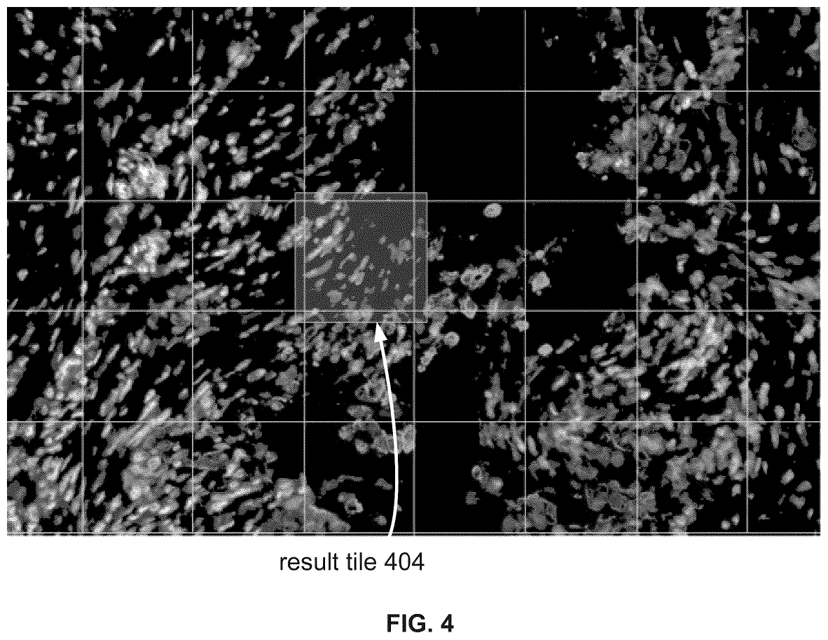

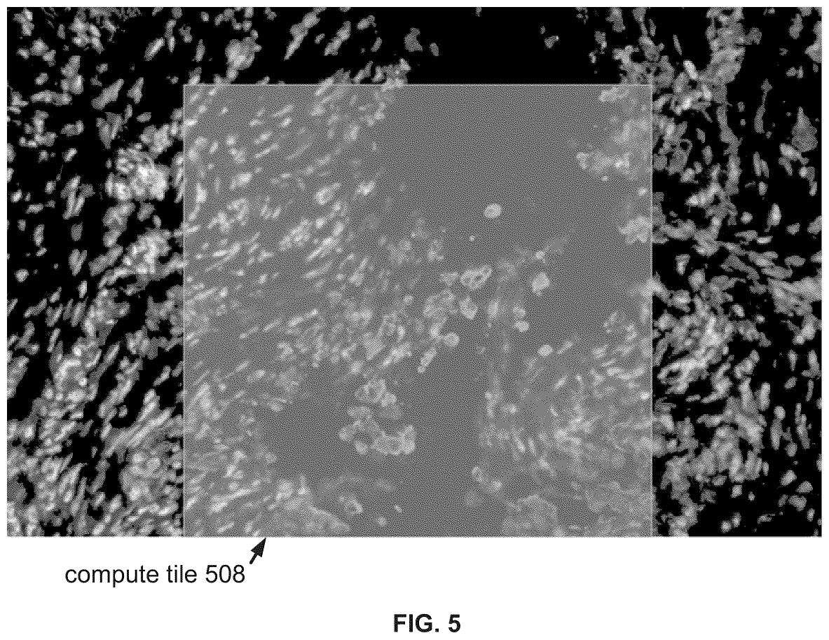

Each result tile includes an inner region that does not overlap any other result tile in the image, and each compute tile includes an inner region that does not overlap any other compute tile in the result tile. In FIG. 3A, the inner region of result tile 304 is indicated by the outer thick square. FIG. 3B shows the example of FIG. 3A in which a compute tile 308 and an inner region 312 of another compute tile are shaded. FIG. 4 shows an example of a grid dividing a portion of an MPX image into result tiles (with a result tile 404 being indicated in red), and FIG. 5 shows an example of a compute tile 508 (shaded in blue) in a portion of an MPX image.

A two-level tile architecture (e.g., as shown in FIGS. 3A and 3B) may be implemented such that each result tile is read into memory by a corresponding CPU thread, which then processes the individual compute tiles inside the result tile. During the processing, the results associated with the computations may be stored inside each individual result tile and then accumulated in the backend. Such an architecture also supports completely independent processing of each compute tile, with no synchronization required among different parts of the image or different stages of a process. Such computational independence allows for a multithreaded implementation, with multiple or many processors executing in parallel, each processor decoding and processing a corresponding part of the image.

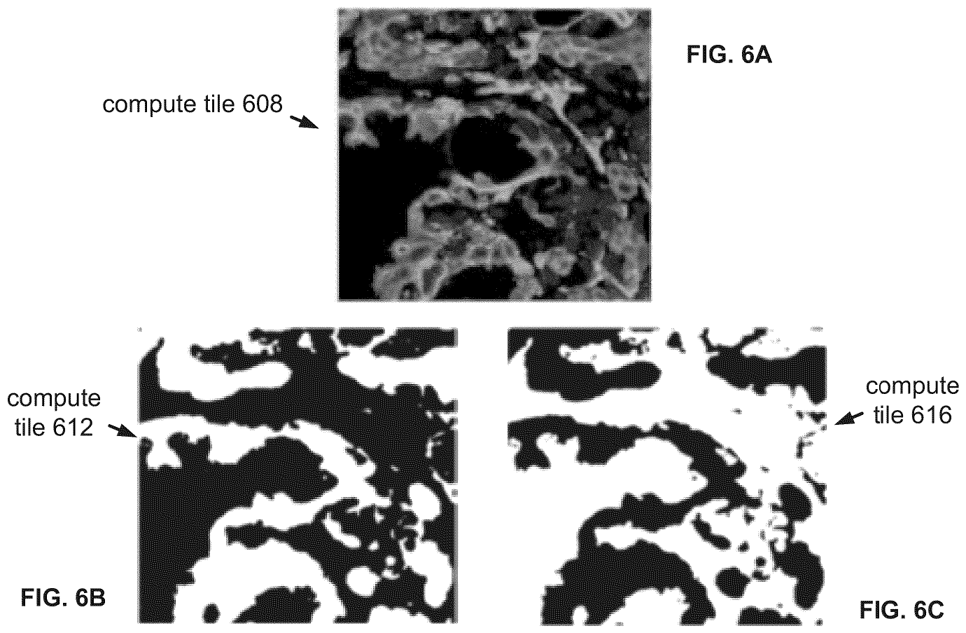

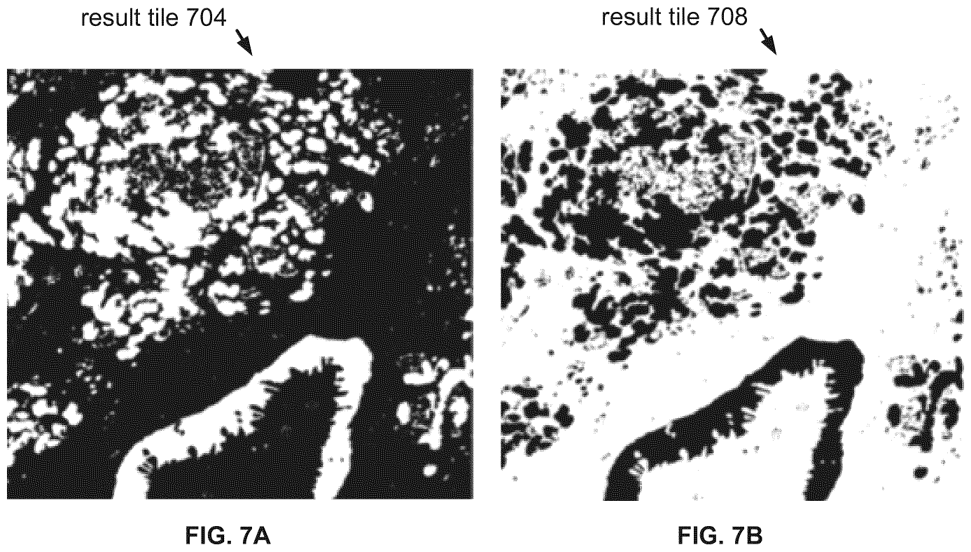

As noted above, describing an image segmentation in the form of polygons may be an imperfect solution leading to processing inefficiencies and/or inaccuracies. It may be desired instead to configure the primary analysis to generate a corresponding binary mask for each layer of the segmentation (e.g., a tumor mask, an epitumor mask, a stroma mask) (also called a “region mask”). Such an approach can be well-suited for a tile-based image analysis process. Use of a pixel-level segmentation mask (e.g., in which each pixel of the mask indicates a membership state of a corresponding pixel of the image) may also avoid a need to convert from polygons to pixels at run-time and/or may resolve inaccuracies at tile boundaries. FIG. 6A shows an example of a compute tile 608 of an MPX image, and FIGS. 6B and 6C show corresponding compute tiles 612 and 616 of an epitumor binary mask and a stroma binary mask, respectively, as generated by segmentation analysis of the image compute tile 608 of FIG. 6A. FIG. 7A shows an example in which compute tiles of an epitumor binary mask have been integrated over a result tile 704, and FIG. 7B shows an example in which compute tiles of a stroma binary mask have been integrated over a result tile 708 (e.g., for use in future readout analysis).

Unfortunately, using binary segmentation masks instead of polygon segmentations may greatly increase storage requirements and/or may lead to multiple disk access operations for each image tile. As binary masks are usually saved as simple images (i.e., one byte per pixel), the amount of disk storage required may increase substantially, and the amount of storage required to maintain such a mask in working memory can be prohibitive for processing for whole slide images. While a tile-based analysis process may allow mask tiles to be swapped into working memory as needed, such an approach also multiplies the number of disk accesses required to perform the analysis.

Use of a sparse binary mask as described herein to represent binary computed region masks (e.g., for epithelium, stroma, and vessel areas) allows operations to be implemented efficiently. For example, it has been shown that the memory requirement may be reduced drastically (i.e., to only a fraction of a bit per pixel).

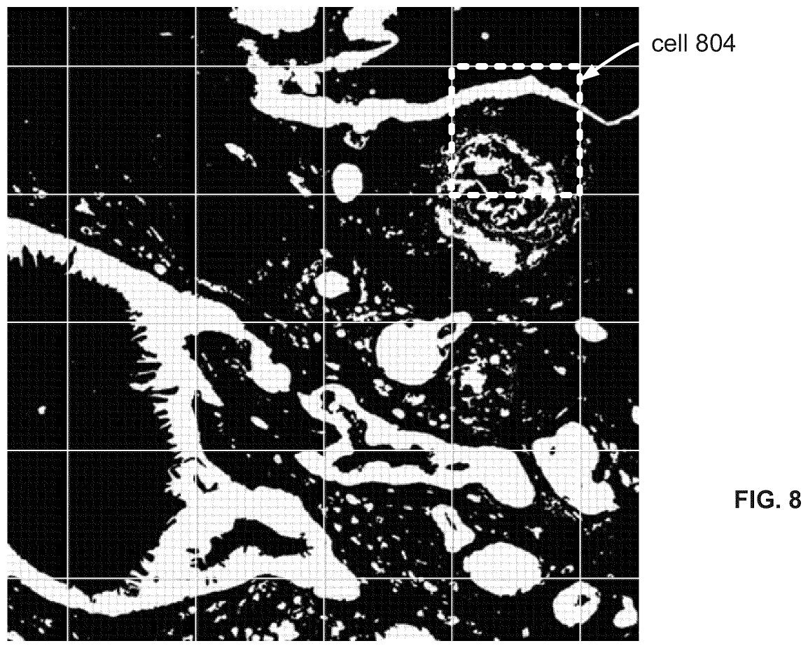

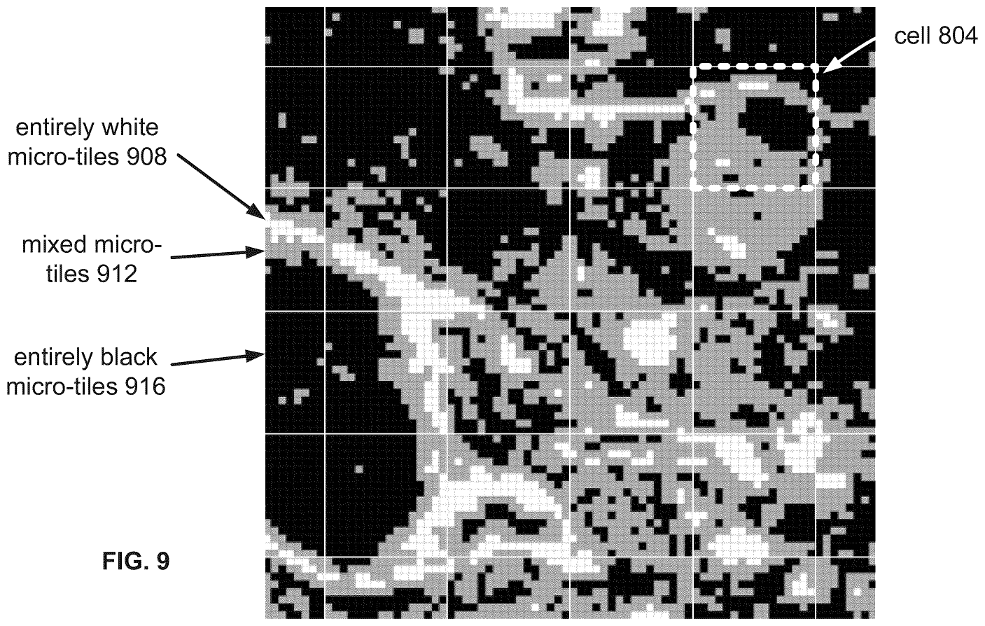

As demonstrated with reference to FIGS. 8 and 9, conversion of a binary mask (e.g., in which each pixel of the mask indicates a membership state of a corresponding pixel of the image) into a sparse binary mask may include dividing the mask image into an array of non-overlapping cells (not to be confused with the biological cells within the tissue section). FIG. 8 shows a portion of a binary computed region mask that is divided (as shown by the grid of white lines) into an array of non-overlapping cells. Each cell (e.g., cell 804) is completely independent of each other cell in the mask image, which supports the use of multiple threads to process the WSI in parallel. Such division of a WSI mask into cells may be performed on the entire mask image at once or in a piecewise (e.g., tile-wise) manner, such as on the integrated result tiles of the mask (e.g., on the inner regions of the result tiles). In one example, the size of each cell is 512×512 pixels, but other cell sizes (e.g., 256×256 pixels, 1024×1024 pixels) are also possible.

As shown in FIG. 8, each cell of the mask image is further divided into an array of non-overlapping micro-tiles (also called “mittels”). In one example, each 512×512-pixel cell is divided into an array of 16×16 micro-tiles, each micro-tile having a size of 32×32 pixels and corresponding to a block of the image that is of the same size as the micro-tile and contains the pixels corresponding to the pixels in the micro-tile. Other micro-tile sizes (e.g., 16×16 pixels, 64×64 pixels) are also possible. Because of the relatively small size of these micro-tiles and the spatial coherency of the binary mask, many of the micro-tiles within a cell contain only “white” pixels (e.g., binary value 1) or only “black” pixels (e.g., binary value 0), while some micro-tiles contain both black pixels and white pixels.

FIG. 9 shows a classification of the micro-tiles of FIG. 8 into three classes. In a first class, all pixels of the micro-tile are black (e.g., binary value 0), and in a second class, all pixels of the micro-tile are white (e.g., binary value 1). Accordingly, the values of all of the pixels of a micro-tile of either of these classes (i.e., the membership values of all of the pixels of the image that correspond to the pixels in the micro-tile) can be represented as a single binary state. In one implementational example of a sparse binary mask representation, no value is stored for micro-tiles of the first class, and a null pointer (or similar flyweight value) is stored for each micro-tile of the second class. In a third class, the micro-tile includes pixels of both binary values (shown as orange (in color) or gray (in grayscale) in FIG. 9). In this case, the value of each pixel of the micro-tile is stored (e.g., as an ordered string of 1024 bits for a micro-tile of size 32×32 pixels). In one implementational example of a sparse binary mask representation, a pool allocator is used to allocate memory for 32×32 bits (128 bytes), and the bit mask for the micro-tile is stored in the allocated memory.

Application of a sparse binary mask implementation as described herein enables a drastic reduction in memory requirement. For example, a typical memory requirement of about 0.2 bit per pixel has been measured in practice with actual MPX WSIs (e.g., as opposed to 8 bits per pixel for a “naive” implementation). Such a reduction allows for in-memory storage of multiple WSI binary masks. In addition, this approach also allows for efficient implementation of various important binary mask operations such as, for example, efficient downsampling and upsampling of binary masks for creation of image resolution pyramids. Use of one or more sparse binary segmentation masks may also enable statistical processing that is not feasible or practical with polygon segmentations (e.g., distributions of distances between biomarkers or other features, co-localization analyses).

The results of primary analysis of an MPX image may include localization of multiple biomarkers by such analysis, which may be used to detect co-localization of biomarkers and phenotypes. Effective detection of all of the different combinations of co-localization among the large MPX data set may be an important condition to enable efficient readout analysis.

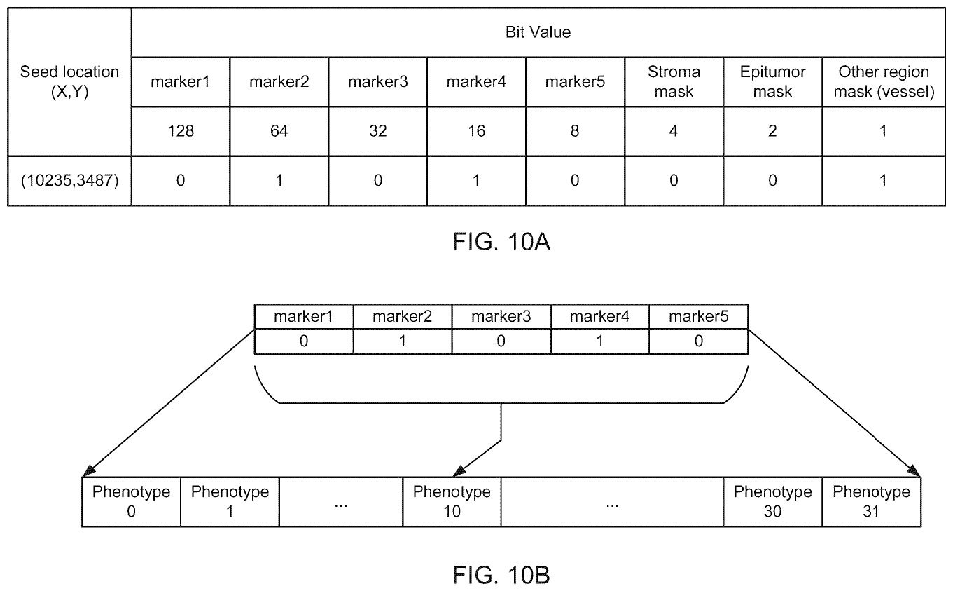

Primary analysis of an MPX image may also include identification of relevant image locations, such as cell nuclei. It may be desired to use such image locations as reference points for localization of detected biomarkers (e.g., for phenotype identification). FIG. 10A shows one example of a bitmap data structure that uses logical bit calculations to record all of the different combinations of phenotype/biomarker co-localization relative to a particular image location (also called a “seed location”). Use of such a data structure may significantly reduce memory usage during computation and detection.

The example of FIG. 10A includes indicators for five different biomarkers (indicated as marker1 to marker5), each biomarker being associated with a unique corresponding position within the bitmap. In this example, the binary value “1” indicates that expression of the marker at the location (e.g., within a predetermined neighborhood of the location, within the boundary of a cell or other biological structure associated with the location) was detected, and the binary value “0” indicates that expression of the marker at the location was not detected. As shown in FIG. 10B, the particular example shown in FIG. 10A thus supports identification of up to 32 different phenotypes (e.g., unique combinations of expression of each of the five biomarkers). These 32 phenotypes are indexed in FIG. 10B as Phenotypes 0 to 31 according to the decimal value of the string of bits that are assigned to the markers marker1 to marker5, with the particular string as shown in FIG. 10A corresponding to Phenotype 10. It will be understood that this data structure may be extended to include such an indicator of expression for each of an arbitrary number of different biomarkers at a location.

Additionally or alternatively, such a bitmap data structure may include binary indicators that each correspond to a different tissue region (e.g., as indicated by a corresponding segmentation as described herein). The example of FIG. 10A includes three additional binary indicators that each correspond to a different segmentation mask (e.g., a sparse binary mask as described herein). In this example and without limitation, the three masks are a stroma mask, an epitumor mask, and an ‘other region’ (e.g., vessel) mask, and the binary value “1” indicates that the mask identifies the location as being included in the corresponding tissue region (e.g., based on the mask value corresponding to the location; or based on the majority of the mask values corresponding to the pixel locations within a predetermined neighborhood of the location, or within the boundary of a cell or other biological structure associated with the location), and the binary value “0” indicates that the mask identifies the location as being excluded from the corresponding tissue region. It will be understood that this data structure may be extended to include such an indicator of region membership for a location for each of an arbitrary number of different regions (e.g., stroma, epitumor, tumor, ‘other region’).

In the particular example of FIG. 10A, all of the information from the MPX data that is relevant to this location for a particular readout analysis is stored in a single byte. By encoding all important information as a combined bit pattern into one (or potentially multiple) bytes and storing that information only for relevant locations of the image (e.g., the center of each cell), a data representation that can be queried very efficiently may be obtained. In some implementations, once such information has been calculated and recorded by the corresponding processor in such a bitmap data structure for each of the identified relevant locations within the inner region of a result tile of an MPX image, the image tile and any corresponding segmentation mask tiles may be discarded from memory.

It may be desired to compute spatial relationships among different biomarkers in specific regions of interest (for example, in tumors and active stromal areas). Knowledge of such complex spatial relationships may enable a better understanding of relations among different biomarkers/phenotypes and region areas (such as blood vessels, active stroma, tumor, etc.). One example of such a computation may include the following operations: (1) For each occurrence of phenotype A in the MPX image (or selected portion thereof), find and record the distance (e.g., Euclidean distance) to the closest occurrence of phenotype B. (2) Optionally, calculate a histogram of the recorded distances (e.g., count the number of distances that are 10 microns or less, the number of distances that are greater than 10 microns and 20 microns or less, . . . , the number of distances that are greater than 90 microns and 100 microns or less, etc.). (3) Optionally, calculate other statistical data, such as an average (e.g., mean) of the collected distances, a standard deviation of the collected distances, etc. It will be understood that such a computation may use one or more other distance measures (e.g., city-block or L1 distance) instead of or in addition to Euclidean distance, may use distance bins of a different size (and possibly of unequal sizes), and/or may use one or more other average measures (e.g., median, mode) instead of or in addition to the mean.

To support computation of spatial relationships among different biomarkers in specific regions of interest, it may be desired to provide a method that may be used for efficiently calculating, for each occurrence of one selected phenotype, the distance to the closest occurrence of a different selected phenotype. It may be desired for such a method to support such calculation for any arbitrary pair of localized phenotypes, or even for any arbitrary pair of combinations of localized phenotypes. Additionally or alternatively, it may be desired for such a method to support further limiting one or more of the phenotype selections by other factors (e.g., occurrence within a particular tissue region, such as epitumor or stroma). It is noted that a bitmap data structure are described herein with reference to FIGS. 10A and 10B may be used to support efficient selection of image locations that match a desired phenotype selection.

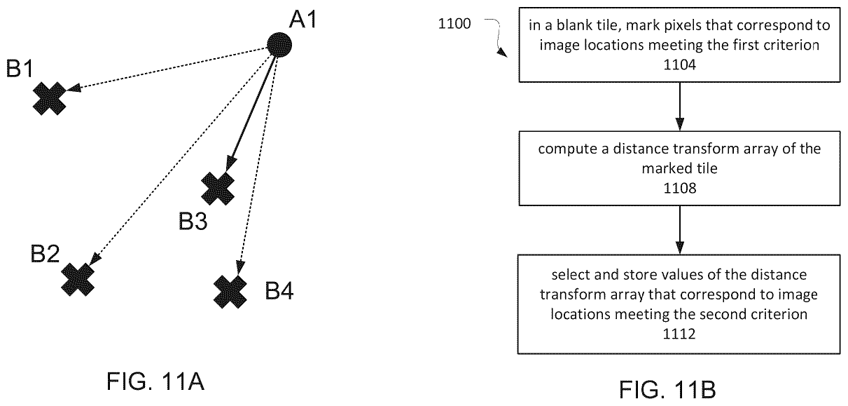

FIG. 11A illustrates an example of an image portion in which there is a single occurrence A1 of a phenotype A and four occurrences B1, B2, B3, B4 of a phenotype B. Among the distances A1-B1, A1-B2, A1-B3, A1-B4 between the occurrences of these two phenotypes, the shortest distance is the distance A1-B3.

FIG. 11B is a flowchart illustrating an example of a method 1100 for computing distances between locations of a medical image (e.g., an MPX image) that meet first and second criteria according to some aspects of the present disclosure. Referring to FIG. 11B, at block 1104, pixels in a blank tile that correspond to image locations which meet a first criterion are marked to produce a marked tile. In one non-limiting example, all of the pixels of the marked tile have the binary value “0” except for the marked pixels, which have the binary value “1”. The first criterion may be, for example, a first selected phenotype (or a first combination of selected phenotypes), possibly further limited to a particular tissue region. In one example, the blank tile is a blank result tile that corresponds to a result tile of the MPX image (i.e., each pixel of the blank tile corresponds to a pixel at the same location of the result tile of the MPX image).

At block 1108, a distance transform array is computed for the marked tile. For each pixel of the marked tile, the distance transform array has a corresponding value that indicates the distance, within the marked tile, from that pixel to the closest marked pixel. At block 1112, the values of the distance transform array that correspond to image locations that meet the second criterion are selected and stored. The second criterion may be, for example, a second selected phenotype (or a second combination of selected phenotypes), possibly further limited to a particular tissue region. In such manner, an instance of method 1100 may be performed (e.g., in parallel) for each tile of interest (e.g., each result tile of the image, or each result tile within an annotation of an image), with the selected values for each tile being stored collectively (e.g., to a common hash table) for future processing (e.g., sorting in order of magnitude, histogram calculation, statistical analysis, etc. as described herein). Such processing of the sorted table may include, for example, using different custom input variables to calculate a corresponding histogram and report related spatial relationships. Such a process (e.g., including tile-level instances of method 1100) may be repeated (e.g., in parallel) for a different annotation of the image, and/or for different selected first and second criteria for the same annotation of the image or for a different annotation, as often as may be desired.

Values of the distance transform array that are close to the edges of the array may be unreliable. For such reasons, it may be desired at block 1112 to ignore values that are within a predetermined number of elements from any edge of the array. For a case in which the blank tile is a blank result tile that corresponds to a result tile of the MPX image, for example, it may be desired to limit the selection to values from within the portion of the distance transform array that corresponds to the inner region of the result tile (i.e., to limit the selection to values of the distance transform array that correspond to pixels within the inner region of the result tile), and it may be also desired to configure the overlap between result tiles to be at least as great as the maximum closest distance to be recorded.

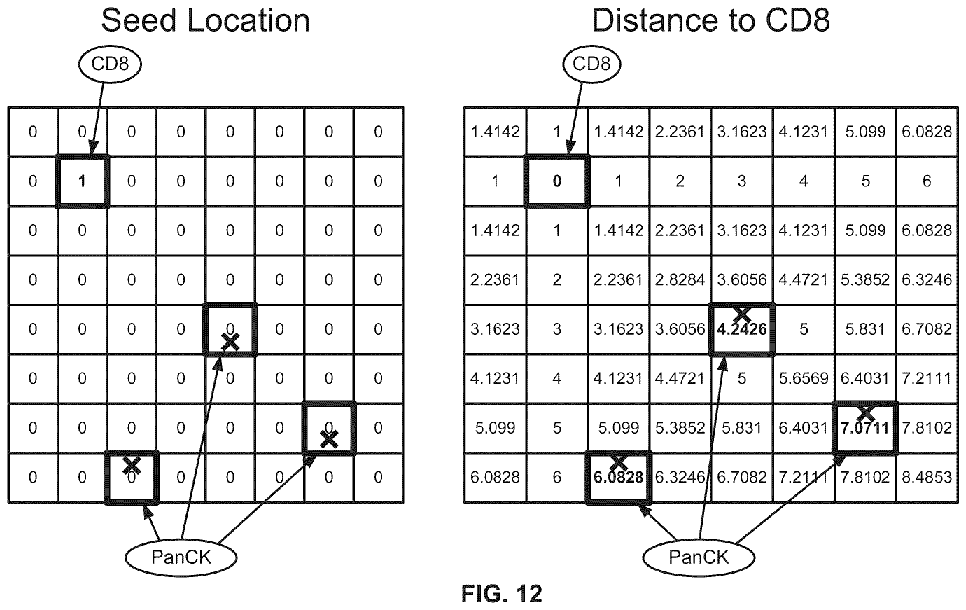

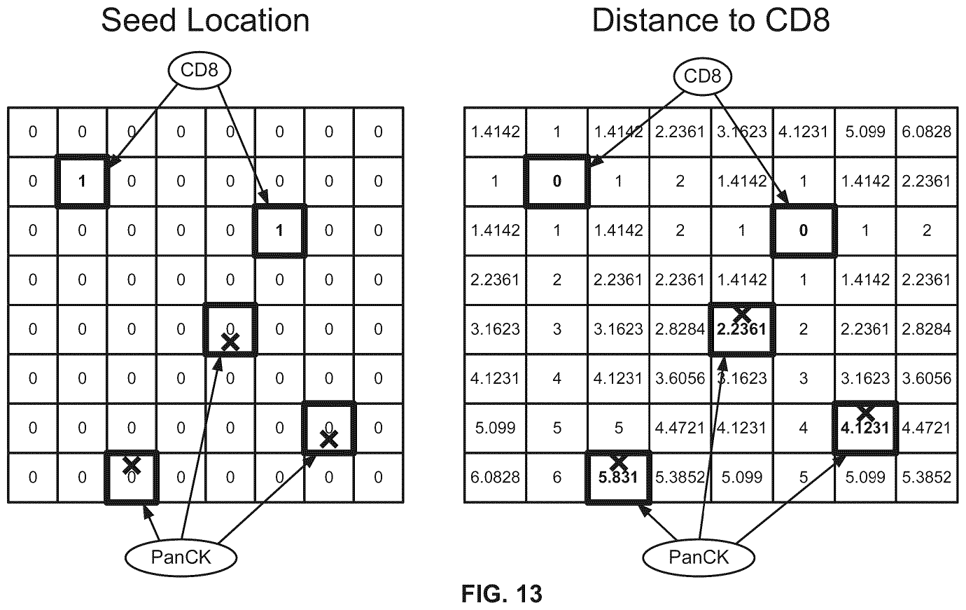

FIG. 12 illustrates an application of method 1100 to computing, recording, and sorting the distance between a first biomarker and a second biomarker. In this example, the first criterion is expression of the CD8 biomarker and the second criterion is expression of the PanCK biomarker. The array on the left-hand side of FIG. 12 shows a portion of the marked result tile (e.g., as produced at block 1104) in which locations corresponding to the CD8 marker are indicated by “1” (in this example, the array includes only one such location). The array on the right-hand side of FIG. 11 shows a corresponding portion of the resulting distance transform array (e.g., as produced at block 1108) which indicates the distance from each corresponding pixel of the image to the location of the CD8 marker. In this example, the locations of the PanCK markers are also indicated within these two arrays (i.e., by the three X's). The values of the distance transform array that correspond to these three locations are selected and stored (e.g., at block 1112) to obtain, for each occurrence of the PanCK marker within this portion of the image, the distance to the closest occurrence of the CD8 marker. In this example, these distances are 4.2426, 6.0828, and 7.0711 pixels. Before these values are stored (e.g., to a hash table), it may be desired to convert them to an actual distance (e.g., in microns) according to a known correspondence between image pixel size and physical dimension. FIG. 13 illustrates a similar application of method 1100 to computing, recording, and sorting the distance between a first biomarker and a second biomarker in which the CD8 marker occurs at multiple locations.

A further level of analysis (“tertiary analysis”) may include statistical analysis of arbitrary areas of interest in the analyzed MPX slide. For example, it may be desired to provide a readout of desired statistical results (e.g., as obtained by instances of method 1100) as they pertain to cells of the tissue that fall within a complex user annotation of the MPX image, where the annotation usually consists of a combination of hand-drawn inclusion and exclusion regions of arbitrary shape and size. It may further be desired to provide such results interactively (e.g., in real time).

Such an operation of retrieving information associated with an arbitrary area of interest may be called a “spatial query.” To enable rapid collection of such information (e.g., to allow for interactivity), support for spatial queries may be implemented using a hierarchical data structure, such as a quadtree. Such an approach also allows for the use of algorithms for efficient quad-tree traversal and polygon clipping. Additionally or alternatively, it may be desired to store the image data and/or analysis results using an internal data order that allows for efficient compression (e.g., using Hilbert curves, which map the 2D image space to a 1D storage space for efficient querying and retrieval).

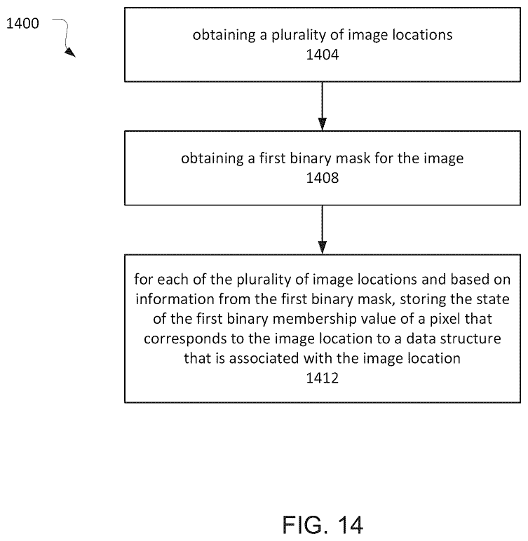

FIG. 14 is a flowchart illustrating an example of a method 1400 for analyzing an image of a tissue section that comprises a plurality of pixels and depicts a plurality of biological structures according to some aspects of the present disclosure. Referring to FIG. 14, at block 1404, a plurality of image locations are obtained (e.g., via analysis of the image and/or from storage). In some instances, each of the image locations corresponds to a different one of the plurality of biological structures and indicates a location of a depiction of the biological structure within the image. The image may be a WSI (e.g., an MPX WSI) or a portion (e.g., a tile) of such an image.

At block 1408, a first binary mask for the image is obtained (e.g., via analysis of the image and/or from storage). The first binary mask indicates, for each of the plurality of pixels of the image, a corresponding state of a first binary membership value. The first binary mask may include a plurality of pixel membership values and a plurality of micro-tile membership values, each of the plurality of pixel membership values corresponding to a different one of the plurality of pixels and indicating the state of the first binary membership value for the pixel, and each of the plurality of micro-tile membership values corresponding to a different one of the plurality of micro-tiles and indicating the state of the first binary membership value for all of the pixels within a block of the image that corresponds to the micro-tile.

At block 1412, for each of the plurality of image locations and based on information from the first binary mask, the state of the first binary membership value of a pixel that corresponds to the image location is stored to a data structure that is associated with the image location. In some aspects, for each of the plurality of image locations, the data structure associated with the image location may include a first binary marker value that indicates a positivity state of a first biomarker at the corresponding biological structure.

In some aspects, for each of the plurality of image locations, the data structure associated with the image location may include a first binary marker value that indicates a positivity state of a first biomarker at the corresponding biological structure. In such case, method 1400 may further include, for each of a plurality of overlapping tiles of the image, calculating a distance transform array that includes, for each pixel of the tile, a corresponding value that indicates a distance between the pixel and a closest among the plurality of image locations for which the first binary marker value indicates a first positivity state.

In some aspects, for each of the plurality of image locations, the data structure associated with the image location may include a second binary marker value that indicates a positivity state of a second biomarker at the corresponding biological structure, and each of the plurality of tiles may include an inner region that does not overlap the inner region of any other tile among the plurality of tiles. In such case, method 1400 may further include, for each of the inner regions, storing values of the distance transform array of the corresponding tile that correspond to image locations for which the second binary marker value indicates a first positivity state.

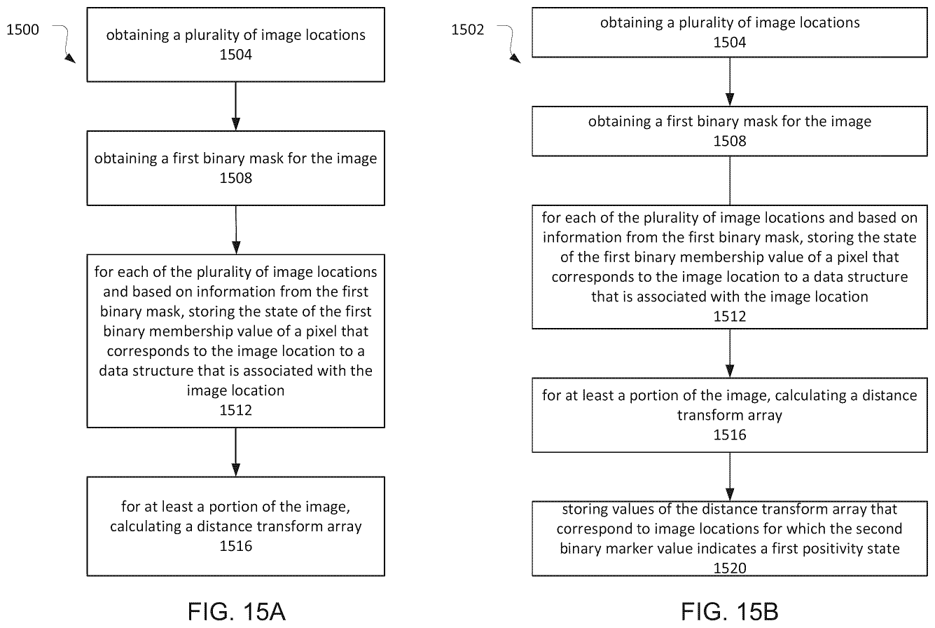

FIG. 15A is a flowchart illustrating an example of an implementation 1500 of method 1400 for analyzing an image of a tissue section that comprises a plurality of pixels and depicts a plurality of biological structures according to some aspects of the present disclosure. Referring to FIG. 15, blocks 1504, 1508, and 1512 may be implementations of blocks 1404, 1408, and 1412, respectively, as described herein. At block 1516, for at least a portion of the image, a distance transform array is calculated, wherein each value of the distance transform array corresponds to a different respective pixel of the image and indicates a distance between the pixel and a closest among the plurality of image locations for which the first binary marker value indicates a first positivity state. In some aspects, for each of the plurality of image locations, the data structure associated with the image location may include a second binary marker value that indicates a positivity state of a second biomarker at the corresponding biological structure.

FIG. 15B is a flowchart illustrating an example of an implementation 1502 of method 1500 for analyzing an image of a tissue section that comprises a plurality of pixels and depicts a plurality of biological structures according to some aspects of the present disclosure. Referring to FIG. 15, blocks 1504, 1508, 1512, and 1516 may be as described herein. At block 1520, values of the distance transform array that correspond to image locations for which the second binary marker value indicates a first positivity state may be stored. In some aspects, the method may yet further include sorting the stored values in order of magnitude.

It should be appreciated that the specific blocks illustrated in FIGS. 14, 15A, and 15B provide particular methods for analyzing an image of a tissue section that comprises a plurality of pixels and depicts a plurality of biological structures according to embodiments as disclosed herein. Other sequences of such operations may also be performed according to alternative embodiments. For example, alternative embodiments of such methods may perform the operations outlined above in a different order. Moreover, the individual blocks illustrated in FIGS. 14, 15A, and 15B may include multiple sub-operations that may be performed in various sequences as appropriate to the individual block. Furthermore, additional operations may be added or removed depending on the particular applications. One of ordinary skill in the art would recognize many variations, modifications, and alternatives. In any of the various aspects or implementations of these methods as, for example, set forth above, each of the plurality of biological structures may be a cell nucleus. Additionally or alternatively, the image may be a multiplexed immunofluorescence (MPX) image having a plurality of channels (e.g., 3, 4, 5, 6, 7 or more, 32, or 64).

Any of the methods 1400, 1500, and 1502 may further include obtaining a second binary mask for the image, the second binary mask indicating, for each of the plurality of pixels, a corresponding state of a second binary membership value. The second binary mask may include a plurality of pixel membership values and a plurality of micro-tile membership values, each of the plurality of pixel membership values corresponding to a different one of the plurality of pixels and indicating the state of the second binary membership value for the pixel, and each of the plurality of micro-tile membership values corresponding to a different one of the plurality of micro-tiles and indicating the state of the second binary membership value for all of the pixels within a block of the image that corresponds to the micro-tile. In some aspects, such a method further includes, for each of the plurality of image locations and based on information from the second binary mask, storing the state of the second binary membership value of a pixel that corresponds to the image location to the data structure that is associated with the image location.

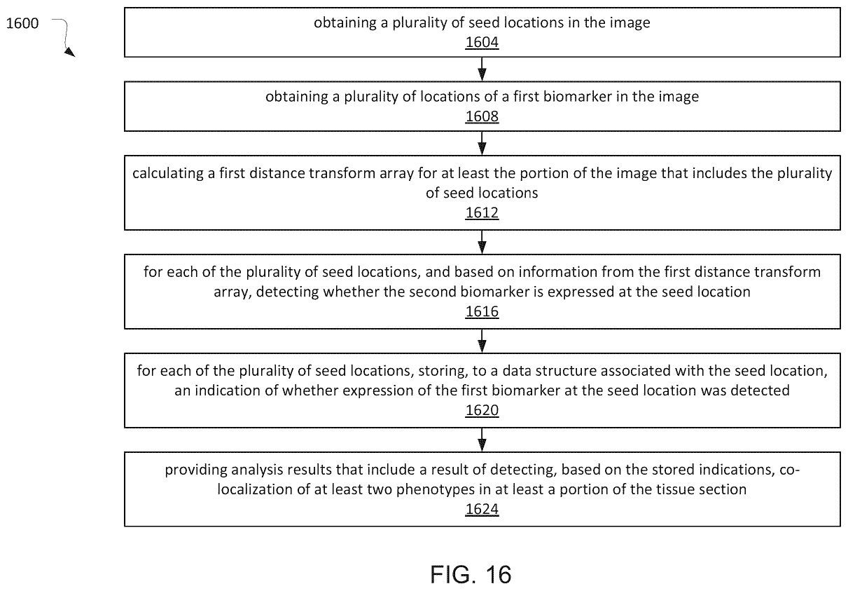

FIG. 16 is a flowchart illustrating an example of a method 1600 for analyzing an image of a tissue section that comprises a plurality of pixels and depicts a plurality of biological structures according to some aspects of the present disclosure. Referring to FIG. 16, at block 1604, a plurality of seed locations in the image are obtained (e.g., via analysis of the image and/or from storage). In some instances, each of the image locations corresponds to a different one of the plurality of biological structures and indicates a location of a depiction of the biological structure within the image. The image may be a WSI (e.g., an MPX WSI) or a portion (e.g., a tile) of such an image.

At block 1608, a plurality of locations of a first biomarker in the image are obtained. In some instances, the plurality of seed locations are obtained from a first channel of the image, and the plurality of locations of a first biomarker are obtained from a second channel of the image.

At block 1612, a first distance transform array for at least a portion of the image that includes the plurality of seed locations is calculated, each value of the first distance transform array corresponding to a respective pixel among the plurality of pixels and indicating a distance from the pixel to a closest among the plurality of locations of the first biomarker.

At block 1616, for each of the plurality of seed locations, and based on information from the first distance transform array, whether the first biomarker is expressed at the seed location is detected. At block 1620, for each of the plurality of seed locations, an indication of whether expression of the first biomarker at the seed location was detected is stored to a data structure associated with the seed location.

At block 1624, analysis results are provided that include a result of detecting, based on the stored indications, co-localization of at least two phenotypes in at least a portion of the tissue section. In some instances, detecting co-localization of the at least two phenotypes includes detecting that a first phenotype of the at least two phenotypes occurs within a predetermined neighborhood of a second phenotype of the at least two phenotypes.

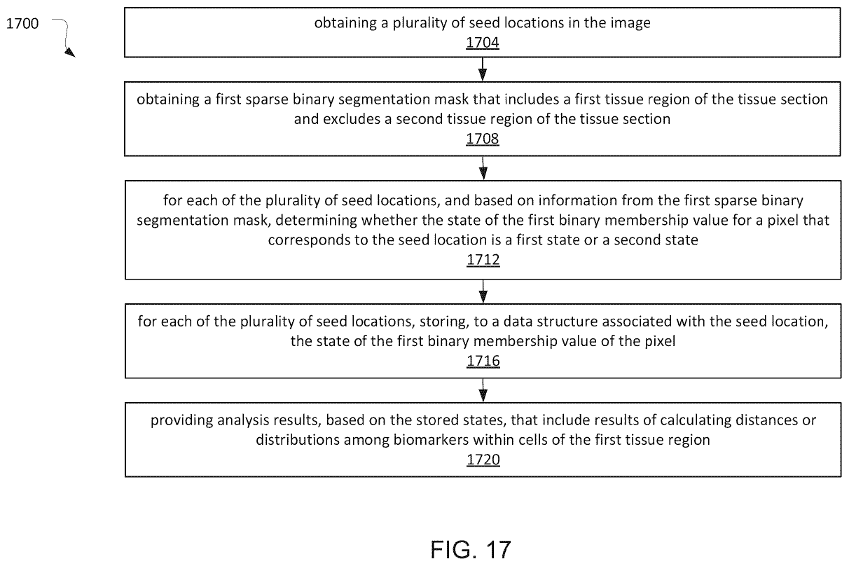

FIG. 17 is a flowchart illustrating an example of a method 1700 for analyzing an image of a tissue section that comprises a plurality of pixels and depicts a plurality of biological structures according to some aspects of the present disclosure. Referring to FIG. 17, at block 1704, a plurality of seed locations in the image are obtained (e.g., via analysis of the image and/or from storage). In some instances, each of the image locations corresponds to a different one of the plurality of biological structures and indicates a location of a depiction of the biological structure within the image. The image may be a WSI (e.g., an MPX WSI) or a portion (e.g., a tile) of such an image.

At block 1708, a first sparse binary segmentation mask that includes a first tissue region of the tissue section and excludes a second tissue region of the tissue section is obtained. The first sparse binary segmentation mask includes a plurality of pixel membership values and a plurality of micro-tile membership values and indicates, for each of the plurality of pixels, a corresponding state of a first binary membership value. Each of the plurality of pixel membership values corresponds to a respective pixel of the plurality of pixels and indicates the state of the first binary membership value for the pixel. Each of the plurality of micro-tile membership values corresponds to a respective micro-tile of a plurality of micro-tiles of the first binary mask and indicates the state of the first binary membership value for all of the pixels within a block of the image that corresponds to the micro-tile.

At block 1712, for each of the plurality of seed locations, and based on information from the first sparse binary segmentation mask, whether the state of the first binary membership value for a pixel, among the plurality of pixels, that corresponds to the seed location is a first state or a second state is determined. In some instances, determining whether the state of the first binary membership value for a corresponding pixel is a first state or a second state includes detecting that the first sparse binary segmentation mask does not include a pixel membership value for the pixel. At block 1716, for each of the plurality of seed locations, the state of the first binary membership value of the pixel is stored to a data structure associated with the seed location.

At block 1720, analysis results, based on the stored states, are provided that include results of calculating distances or distributions among biomarkers within cells of the first tissue region. In some instances, the analysis results include a density of distribution of at least one phenotype within the first tissue region. In some instances, the analysis results include a distribution of distances between locations of biomarkers within the first tissue region.

The methods 1100, 1400, 1500, 1502, 1600, and 1700, respectively, may be embodied on a non-transitory computer readable medium, for example, but not limited to, a memory or other non-transitory computer readable medium known to those of skill in the art, having stored therein a program including computer executable instructions for making a processor, computer, or other programmable device execute the operations of the methods.

### IV. Exemplary System For Automated Image Analysis

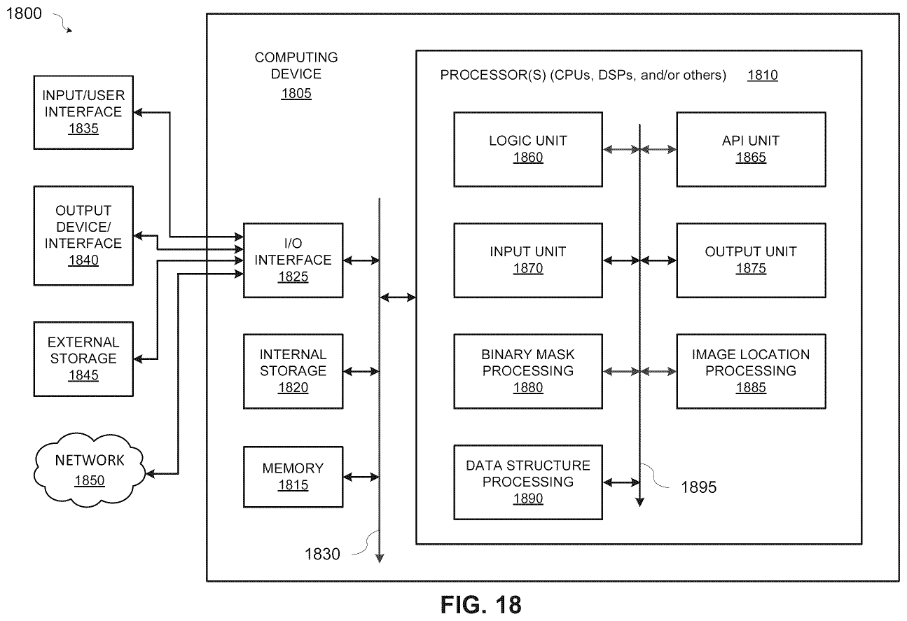

FIG. 18 is a block diagram of an example computing environment with an example computing device suitable for use in some example implementations, for example, performing the methods 1100, 1400, 1500, 1502, 1600 and/or 1700. The computing device 1805 in the computing environment 1800 may include one or more processing units, cores, or processors 1810, memory 1815 (e.g., RAM, ROM, and/or the like), internal storage 1820 (e.g., magnetic, optical, solid state storage, and/or organic), and/or I/O interface 1825, any of which may be coupled on a communication mechanism or a bus 1830 for communicating information or embedded in the computing device 1805.

The computing device 1805 may be communicatively coupled to an input/user interface 1835 and an output device/interface 1840. Either one or both of the input/user interface 1835 and the output device/interface 1840 may be a wired or wireless interface and may be detachable. The input/user interface 1835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). The output device/interface 1840 may include a display, television, monitor, printer, speaker, braille, or the like. In some example implementations, the input/user interface 1835 and the output device/interface 1840 may be embedded with or physically coupled to the computing device 1805. In other example implementations, other computing devices may function as or provide the functions of the input/user interface 1835 and the output device/interface 1840 for the computing device 1805.

The computing device 1805 may be communicatively coupled (e.g., via the I/O interface 1825) to an external storage device 1845 and a network 1850 for communicating with any number of networked components, devices, and systems, including one or more computing devices of the same or different configuration. The computing device 1805 or any connected computing device may be functioning as, providing services of, or referred to as a server, client, thin server, general machine, special-purpose machine, or another label.

The I/O interface 1825 may include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in the computing environment 1800. The network 1850 may be any network or combination of networks (e.g., the Internet, local area network, wide area network, a telephonic network, a cellular network, satellite network, and the like).

The computing device 1805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

The computing device 1805 can be used to implement techniques, methods, applications, processes, or computer-executable instructions in some example computing environments. Computer-executable instructions can be retrieved from transitory media, and stored on and retrieved from non-transitory media. The executable instructions may originate from one or more of any programming, scripting, and machine languages (e.g., C, C++, C#, Java, Visual Basic, Python, Perl, JavaScript, and others).

The processor(s) 1810 may execute under any operating system (OS) (not shown), in a native or virtual environment. One or more applications may be deployed that include a logic unit 1860, an application programming interface (API) unit 1865, an input unit 1870, an output unit 1875, a boundary mapping unit 1880, a control point determination unit 1885, a transformation computation and application unit 1890, and an inter-unit communication mechanism 1895 for the different units to communicate with each other, with the OS, and with other applications (not shown). For example, the binary mask processing unit 1880, the image location processing unit 1885, and the data structure processing unit 1890 may implement one or more processes described and/or shown in FIGS. 14, 15A, and/or 15B. The described units and elements can be varied in design, function, configuration, or implementation and are not limited to the descriptions provided.

In some example implementations, when information or an execution instruction is received by the API unit 1865, it may be communicated to one or more other units (e.g., the logic unit 1860, the input unit 1870, the output unit 1875, the binary mask processing unit 1880, the image location processing unit 1885, and the data structure processing unit 1890). For example, after the input unit 1870 has detected user input, it may use the API unit 1865 to communicate the user input to the binary mask processing unit 1880 to obtain a first binary mask. The binary mask processing unit 1880 may, via the API unit 1865, interact with the image location processing unit 1885 to determine the state of the first binary membership value of a pixel that corresponds to the image location. Using the API unit 1865, the image location processing unit 1885 may interact with the data structure processing unit 1890 to store the state of the first binary membership value of a pixel that corresponds to the image location to a data structure that is associated with the image location. Further example implementations of applications that may be deployed may include a distance transform array calculating unit to calculate a distance transform array as described herein (e.g., with reference to FIG. 11B).

In some instances, the logic unit 1860 may be configured to control the information flow among the units and direct the services provided by the API unit 1865, the input unit 1870, the output unit 1875, the binary mask processing unit 1880, the image location processing unit 1885, and the data structure processing unit 1890 in some example implementations described above. For example, the flow of one or more processes or implementations may be controlled by the logic unit 1860 alone or in conjunction with the API unit 1865.

For one or more embodiments, at least one of the components set forth in one or more of the preceding figures may be configured to perform one or more operations, techniques, processes, or methods as set forth in the examples which follow and the claims as presented below.

### V. Examples

In the following sections, further exemplary embodiments are provided.

Example 1 includes a method for analyzing an image of a tissue section that comprises a plurality of pixels and depicts a plurality of biological structures, the method comprising: obtaining a plurality of image locations, each of the image locations corresponding to a different one of the plurality of biological structures and indicating a location of a depiction of the biological structure within the image; and obtaining a first binary mask for the image, the first binary mask indicating, for each of the plurality of pixels of the image, a corresponding state of a first binary membership value, wherein the first binary mask includes a plurality of pixel membership values and a plurality of micro-tile membership values, each of the plurality of pixel membership values corresponding to a different one of the plurality of pixels and indicating the state of the first binary membership value for the pixel, and each of the plurality of micro-tile membership values corresponding to a different one of the plurality of micro-tiles and indicating the state of the first binary membership value for all of the pixels within a block of the image that corresponds to the micro-tile, and wherein the method further comprises, for each of the plurality of image locations and based on information from the first binary mask, storing the state of the first binary membership value of a pixel that corresponds to the image location to a data structure that is associated with the image location.

Example 2 includes the method of Example 1 or some other example herein, wherein for each of the plurality of image locations, the data structure associated with the image location includes a first binary marker value that indicates a positivity state of a first biomarker at the corresponding biological structure.

Example 3 includes the method of Example 2 or some other example herein, wherein the method further comprises, for at least a portion of the image, calculating a distance transform array, wherein each value of the distance transform array corresponds to a different respective pixel of the image and indicates a distance between the pixel and a closest among the plurality of image locations for which the first binary marker value indicates a first positivity state.

Example 4 includes the method of Example 3 or some other example herein, wherein for each of the plurality of image locations, the data structure associated with the image location includes a second binary marker value that indicates a positivity state of a second biomarker at the corresponding biological structure.

Example 5 includes the method of Example 4 or some other example herein, wherein the method further comprises storing values of the distance transform array that correspond to image locations for which the second binary marker value indicates a first positivity state.

Example 6 includes the method of Example 5 or some other example herein, the method further comprising sorting the stored values in order of magnitude.

Example 7 includes the method of Example 1 or some other example herein, wherein for each of the plurality of image locations, the data structure associated with the image location includes a first binary marker value that indicates a positivity state of a first biomarker at the corresponding biological structure, and wherein the method further comprises, for each of a plurality of overlapping tiles of the image, calculating a distance transform array that includes, for each pixel of the tile, a corresponding value that indicates a distance between the pixel and a closest among the plurality of image locations for which the first binary marker value indicates a first positivity state.

Example 8 includes the method of Example 7 or some other example herein, wherein for each of the plurality of image locations, the data structure associated with the image location includes a second binary marker value that indicates a positivity state of a second biomarker at the corresponding biological structure, and wherein each of the plurality of tiles includes an inner region that does not overlap the inner region of any other tile among the plurality of tiles, and wherein the method further comprises, for each of the inner regions, storing values of the distance transform array of the corresponding tile that correspond to image locations for which the second binary marker value indicates a first positivity state.

Example 9 includes the method of any of Examples 1-8 or some other example herein, wherein each of the plurality of biological structures is a cell nucleus.

Example 10 includes the method of any of Examples 1-8 or some other example herein, wherein the image is a multiplexed immunofluorescence image having a plurality of channels.

Example 11 includes a system comprising one or more data processors; and a non-transitory computer readable storage medium containing instructions which, when executed on the one or more data processors, cause the one or more data processors to perform operations of any of Examples 1 to 10 or some other example herein.

Example 12 includes a non-transitory computer readable medium having stored therein instructions for making one or more processors execute a method for analyzing an image of a tissue section that comprises a plurality of pixels and depicts a plurality of biological structures, the processor executable instructions comprising instructions for performing operations including obtaining a plurality of image locations, each of the image locations corresponding to a different one of the plurality of biological structures and indicating a location of a depiction of the biological structure within the image; and obtaining a first binary mask for the image, the first binary mask indicating, for each of the plurality of pixels of the image, a corresponding state of a first binary membership value, wherein the first binary mask includes a plurality of pixel membership values and a plurality of micro-tile membership values, each of the plurality of pixel membership values corresponding to a different one of the plurality of pixels and indicating the state of the first binary membership value for the pixel, and each of the plurality of micro-tile membership values corresponding to a different one of the plurality of micro-tiles and indicating the state of the first binary membership value for all of the pixels within a block of the image that corresponds to the micro-tile, and wherein the operations further comprise, for each of the plurality of image locations and based on information from the first binary mask, storing the state of the first binary membership value of a pixel that corresponds to the image location to a data structure that is associated with the image location.

Example 13 includes the non-transitory computer readable medium of Example 12 or some other example herein, wherein for each of the plurality of image locations, the data structure associated with the image location includes a first binary marker value that indicates a positivity state of a first biomarker at the corresponding biological structure.

Example 14 includes the non-transitory computer readable medium of Example 13 or some other example herein, further comprising instructions for performing operations including: for at least a portion of the image, calculating a distance transform array, wherein each value of the distance transform array corresponds to a different respective pixel of the image and indicates a distance between the pixel and a closest among the plurality of image locations for which the first binary marker value indicates a first positivity state.

Example 15 includes the non-transitory computer readable medium of Example 14 or some other example herein, wherein for each of the plurality of image locations, the data structure associated with the image location includes a second binary marker value that indicates a positivity state of a second biomarker at the corresponding biological structure.

Example 16 includes the non-transitory computer readable medium of Example 15 or some other example herein, further comprising instructions for performing operations including storing values of the distance transform array that correspond to image locations for which the second binary marker value indicates a first positivity state.

Example 17 includes the non-transitory computer readable medium of Example 16 or some other example herein, further comprising instructions for performing operations including sorting the stored values in order of magnitude.

Example 18 includes the non-transitory computer readable medium of Example 12 or some other example herein, wherein for each of the plurality of image locations, the data structure associated with the image location includes a first binary marker value that indicates a positivity state of a first biomarker at the corresponding biological structure, and the medium further comprising instructions for performing operations including, for each of a plurality of overlapping tiles of the image, calculating a distance transform array that includes, for each pixel of the tile, a corresponding value that indicates a distance between the pixel and a closest among the plurality of image locations for which the first binary marker value indicates a first positivity state.

Example 19 includes the non-transitory computer readable medium of Example 18 or some other example herein, wherein for each of the plurality of image locations, the data structure associated with the image location includes a second binary marker value that indicates a positivity state of a second biomarker at the corresponding biological structure, and wherein each of the plurality of tiles includes an inner region that does not overlap the inner region of any other tile among the plurality of tiles, and the medium further comprising instructions for performing operations including, for each of the inner regions, storing values of the distance transform array of the corresponding tile that correspond to image locations for which the second binary marker value indicates a first positivity state.

Example 20 includes the non-transitory computer readable medium of any of Examples 12-19 or some other example herein, wherein each of the plurality of biological structures is a cell nucleus.

### VI. Additional Considerations

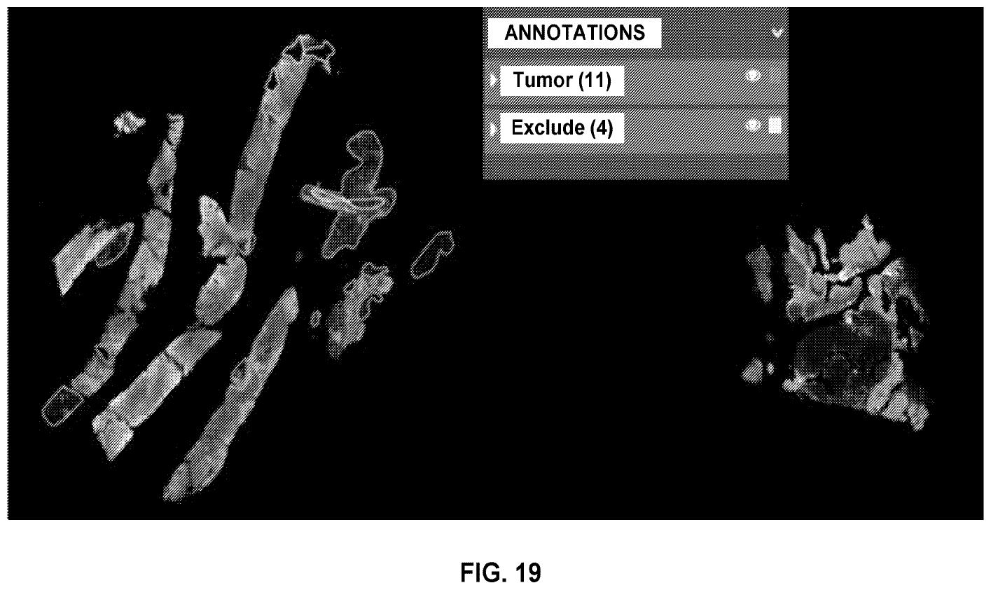

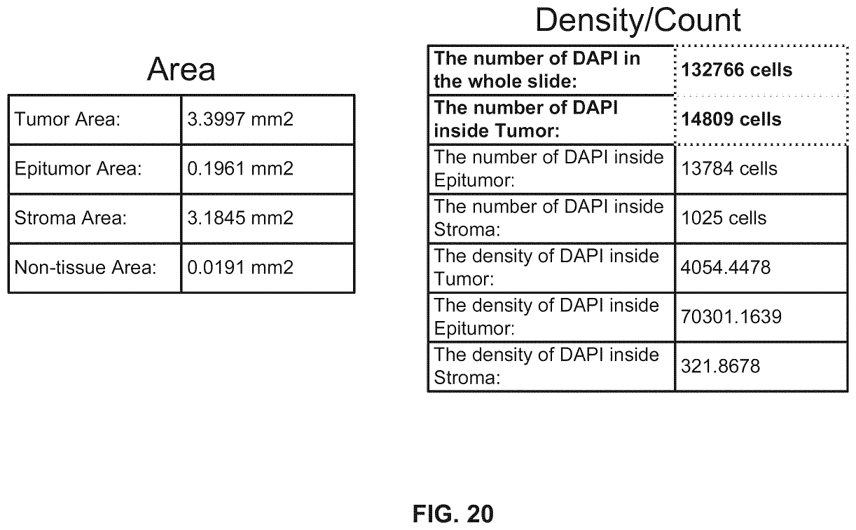

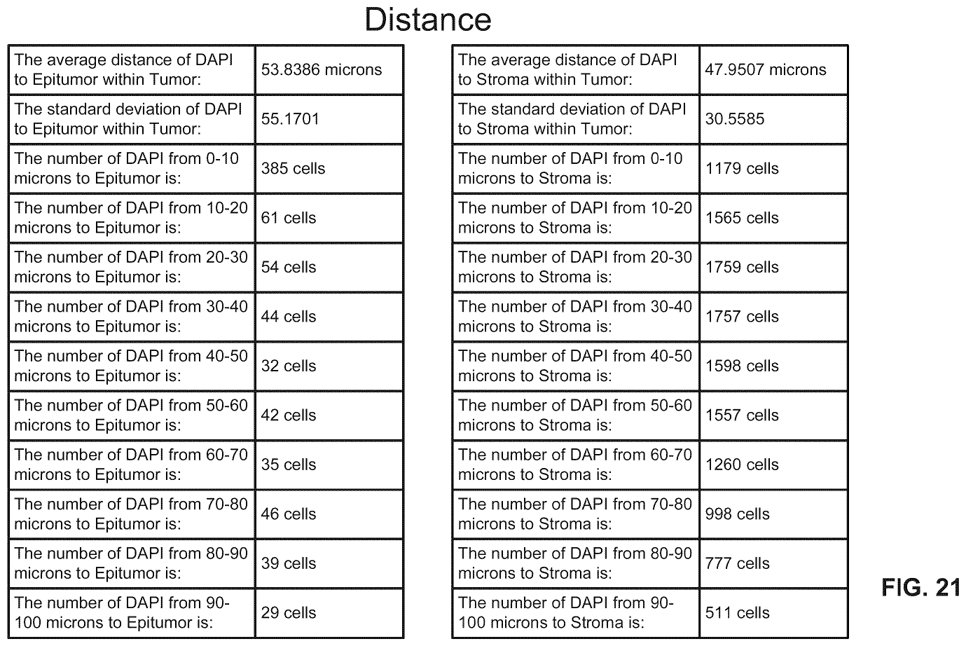

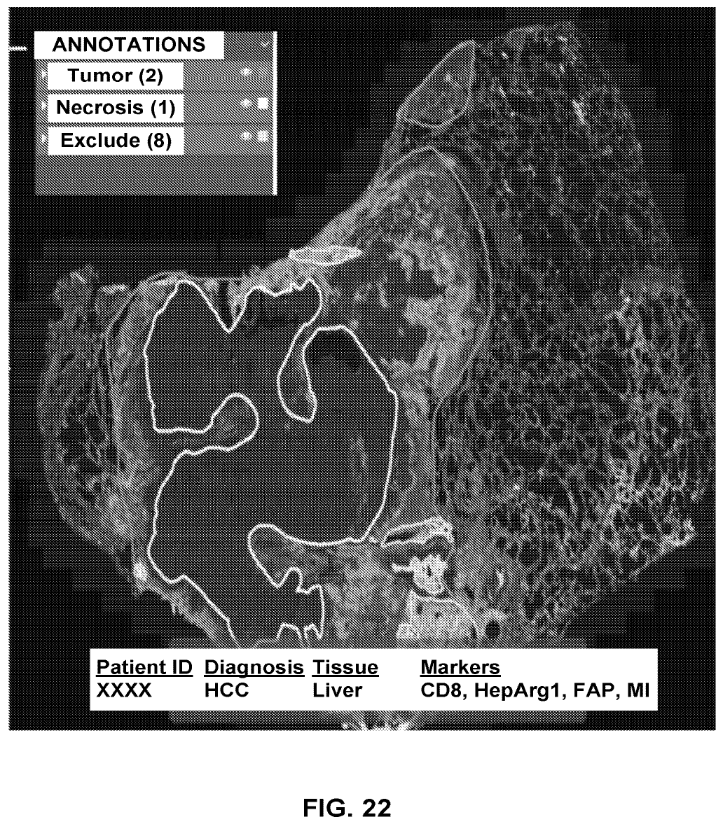

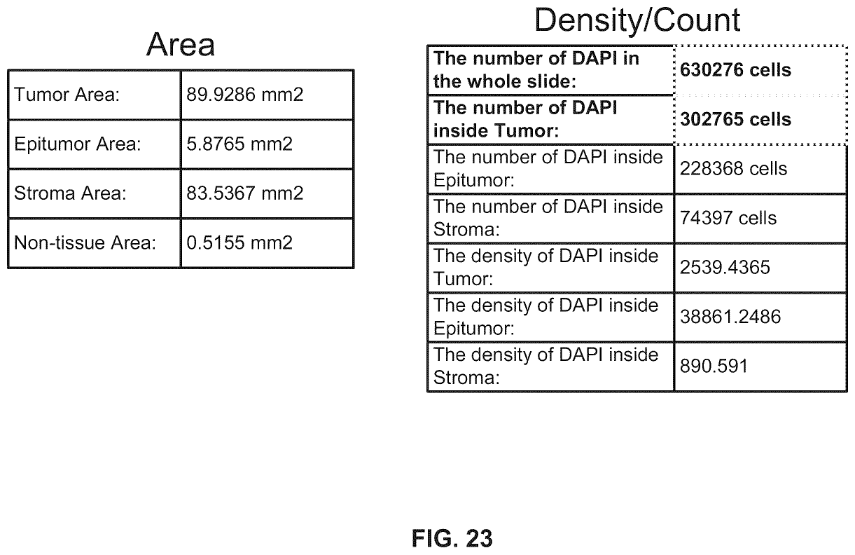

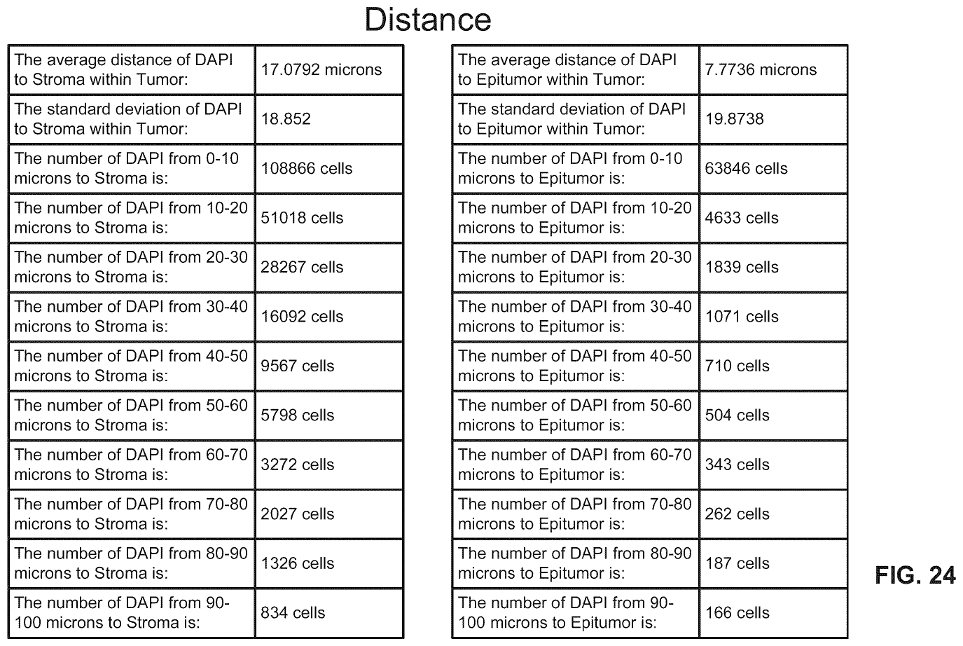

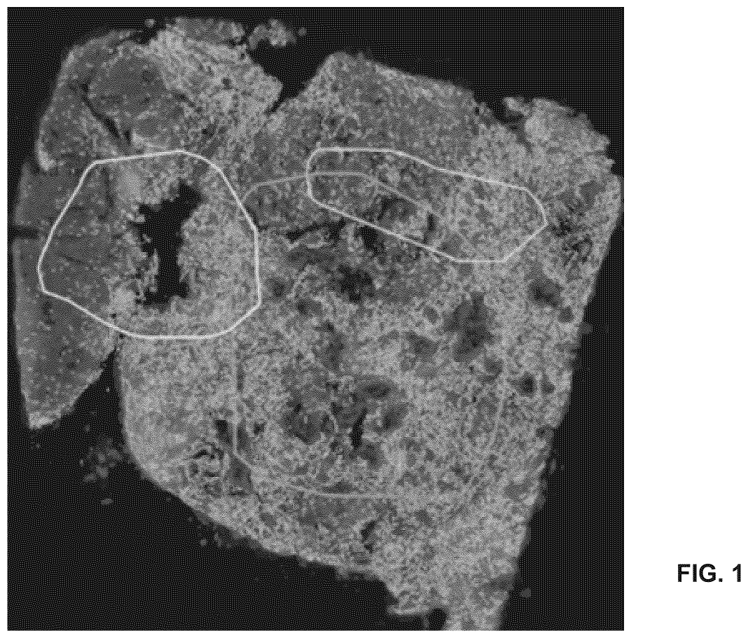

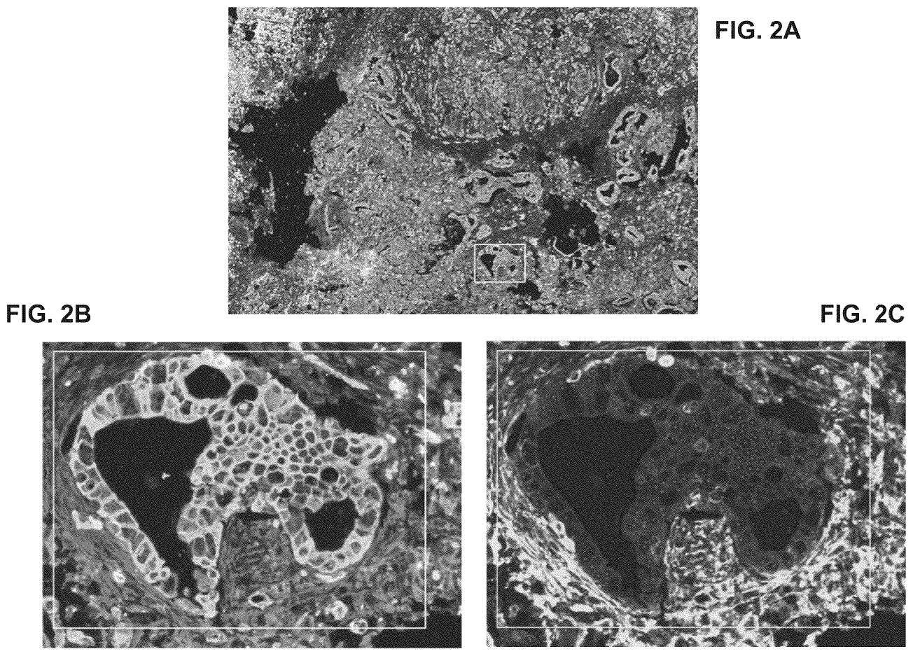

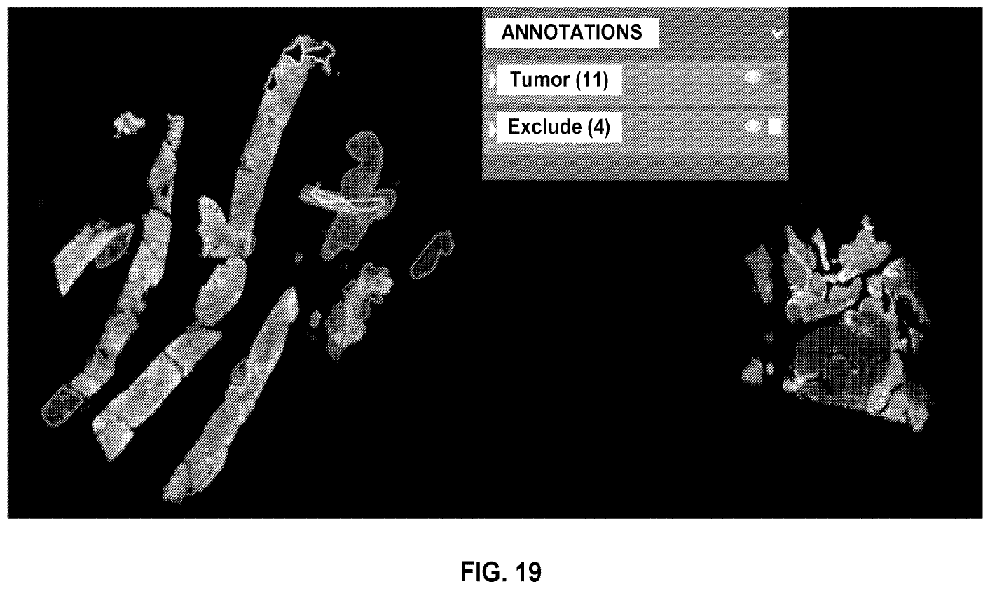

FIG. 19 shows an example of an annotated MPX image of a small multi-tissue biopsy, and FIGS. 20 and 21 show examples of area, density distribution, and distance distribution results that may be obtained from such an image using implementations of methods 1100, 1300, 1400, and/or 1402 as described herein. Using an existing framework, it took 2.24 seconds to report density distribution and spatial relationships of 132,766 4′,6-diamidino-2-phenylindole (DAPI)-stained nuclear cells in tumors, epithelial tumors, and stroma as shown in FIGS. 20 and 21 (area and density distribution for DAPI cells; and spatial relationships between DAPI nuclei to tumor, stroma and epitumor regions; respectively).

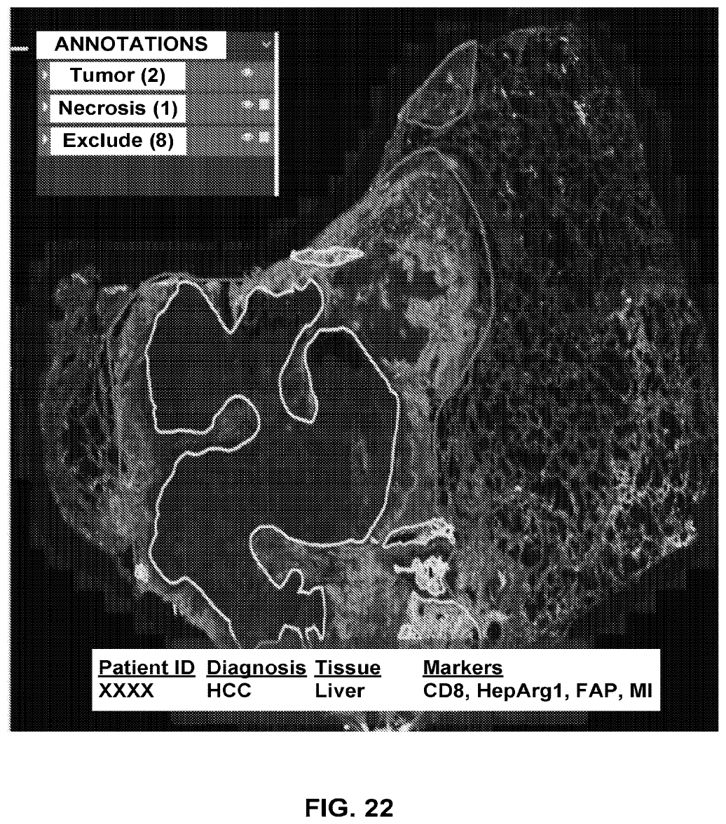

FIG. 22 shows an example of an annotated MPX image of a large tissue section, and FIGS. 23 and 24 show examples of area, density distribution, and distance distribution results that may be obtained from such an image using implementations of methods 1100, 1300, 1400, and/or 1402 as described herein. Using techniques as disclosed herein, it only took 1.13 seconds to report the density distribution and spatial characteristics of 630,276 DAPI nuclei cells as shown in FIGS. 23 and 24 (area and density distribution for DAPI cells; and spatial relationships between DAPI nuclei to tumor, stroma and epitumor regions; respectively), while the existing framework required 231.49 seconds (e.g., the techniques as disclosed herein provided the results 205 times faster than the existing framework).

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The description above provides preferred exemplary embodiments only, and is not intended to limit the scope, applicability or configuration of the disclosure. Rather, the description above of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A method of image analysis, the method comprising:
obtaining a plurality of seed locations in an image of a tissue section that comprises a plurality of pixels and depicts a plurality of biological structures;
obtaining a plurality of locations of a first biomarker in the image;
calculating a first distance transform array for at least a portion of the image that includes the plurality of seed locations, each value of the first distance transform array corresponding to a respective pixel among the plurality of pixels and indicating a distance from the pixel to a closest among the plurality of locations of the first biomarker;
for each of the plurality of seed locations, providing a data structure that is associated with the seed location;
for each of the plurality of seed locations, and based on information from the first distance transform array:
detecting whether the first biomarker is expressed at the seed location, and
storing, to the data structure that is associated with the seed location, a binary indication of whether expression of the first biomarker at the seed location was detected; and
providing analysis results that include a result of detecting, based on the stored indications, co-localization of at least two phenotypes in at least a portion of the tissue section.

2. The method of image analysis according to claim 1, wherein:
obtaining the plurality of seed locations includes identifying the plurality of seed locations within a first channel of the image, and
obtaining the plurality of locations of the first biomarker includes identifying the plurality of locations of the first biomarker within a second channel of the image.

3. The method of image analysis according to claim 1, wherein:
each of the plurality of seed locations corresponds to a different one of the plurality of biological structures and indicates a location of a depiction of the biological structure within the image, and
each of the plurality of first biomarker locations corresponds to a different one of the plurality of biological structures and indicates a location of a depiction of the biological structure within the image.

4. The method of image analysis according to claim 1, wherein each of the plurality of biological structures is a cell nucleus.

5. The method of image analysis according to claim 1, wherein the method further comprises:
obtaining a plurality of locations of a second biomarker in the image;
calculating a second distance transform array for at least the portion of the image that includes the plurality of seed locations, each value of the second distance transform array corresponding to a respective pixel among the plurality of pixels and indicating a distance from the seed location to a closest among the plurality of locations of the second biomarker; and
for each of the plurality of seed locations, and based on information from the second distance transform array:
detecting whether the second biomarker is expressed at the seed location, and
storing, to the data structure that is associated with the seed location, a second indication of whether expression of the second biomarker at the seed location was detected,
wherein detecting co-localization of the at least two phenotypes is based on the stored second locations.

6. The method of image analysis according to claim 1, wherein detecting co-localization of the at least two phenotypes includes detecting that a first phenotype of the at least two phenotypes occurs within a predetermined neighborhood of a second phenotype of the at least two phenotypes.

7. A system comprising:
one or more data processors; and
a non-transitory computer readable storage medium containing instructions which, when executed on the one or more data processors, cause the one or more data processors to perform the method of image analysis according to claim 1.

8. A computer-program product tangibly embodied in a non-transitory machine-readable storage medium, including instructions configured to cause one or more data processors to perform the method of image analysis according to claim 1.

9. A method of image analysis, the method comprising:
obtaining a plurality of seed locations in an image of a tissue section that comprises a plurality of pixels and depicts a plurality of biological structures;
obtaining a first sparse binary segmentation mask that includes a first tissue region of the tissue section and excludes a second tissue region of the tissue section, the first sparse binary segmentation mask including a plurality of pixel membership values and a plurality of micro-tile membership values and indicating, for each of the plurality of pixels, a corresponding state of a first binary membership value;
for each of the plurality of seed locations, and based on information from the first sparse binary segmentation mask:
determining whether the state of the first binary membership value for a pixel, among the plurality of pixels, that corresponds to the seed location is a first state or a second state, and
storing, to a data structure associated with the seed location, the state of the first binary membership value of the pixel; and
providing analysis results, based on the stored states, that include results of calculating distances or distributions among biomarkers within cells of the first tissue region,
wherein:
each of the plurality of pixel membership values corresponds to a respective pixel of the plurality of pixels and indicates the state of the first binary membership value for the pixel, and
each of the plurality of micro-tile membership values corresponds to a respective micro-tile of a plurality of micro-tiles of the first binary mask and indicates the state of the first binary membership value for all of the pixels within a block of the image that corresponds to the micro-tile.

10. The method of image analysis according to claim 9, wherein, for at least one of the plurality of seed locations, determining whether the state of the first binary membership value for the corresponding pixel is a first state or a second state includes detecting that the first sparse binary segmentation mask does not include a pixel membership value for the pixel.

11. The method of image analysis according to claim 9, wherein the analysis results include a density of distribution of at least one phenotype within the first tissue region.

12. The method of image analysis according to claim 9, wherein the analysis results include a distribution of distances between locations of biomarkers within the first tissue region.

13. The method of image analysis according to claim 9, wherein the method further comprises:
obtaining a plurality of locations of a first biomarker in the image;
calculating a first distance transform array for at least a portion of the image that includes the plurality of seed locations, each value of the first distance transform array corresponding to a respective pixel among the plurality of pixels and indicating a distance from the seed location to a closest among the plurality of locations of the first biomarker; and
for each of the plurality of seed locations, and based on information from the first distance transform array:
detecting whether the first biomarker is expressed at the seed location, and
storing, to the data structure associated with the seed location, an indication of whether expression of the first biomarker at the seed location was detected,
wherein the analysis results are based on the stored indications.

14. The method of image analysis according to claim 13, wherein:
obtaining the plurality of seed locations includes identifying the plurality of seed locations within a first channel of the image, and
obtaining the plurality of locations of the first biomarker includes identifying the plurality of locations of the first biomarker within a second channel of the image.

15. The method of image analysis according to claim 13, wherein:
each of the plurality of seed locations corresponds to a different one of the plurality of biological structures and indicates a location of a depiction of the biological structure within the image, and
each of the plurality of locations of the first biomarker corresponds to a different one of the plurality of biological structures and indicates a location of a depiction of the biological structure within the image.

16. The method of image analysis according to claim 9, wherein:
each of the plurality of seed locations corresponds to a different one of the plurality of biological structures and indicates a location of a depiction of the biological structure within the image, and
each of the plurality of biological structures is a cell nucleus.

17. A system comprising:
one or more data processors; and
a non-transitory computer readable storage medium containing instructions which, when executed on the one or more data processors, cause the one or more data processors to perform the method of image analysis according to claim 9.

18. A computer-program product tangibly embodied in a non-transitory machine-readable storage medium, including instructions configured to cause one or more data processors to perform the method of image analysis according to claim 9.

19. The method of image analysis according to claim, 1, wherein the method further comprises:
obtaining a first binary mask for the image; and
for each of the plurality of seed locations, and based on information from the first binary mask, storing a state of a binary membership value of a pixel that corresponds to the seed location to the data structure that is associated with the seed location.

20. The method of image analysis according to claim 1, wherein detecting co-localization of at least two phenotypes comprises detecting, with reference to each of at least some of the plurality of seed locations, co-expression of at least two particular combinations of biomarkers.

21. The method of image analysis according to claim 1, wherein:
the tissue section has been stained with a stain, and
the first biomarker is a target antigen to the stain.

22. The method of image analysis according to claim 1, wherein, for each of the plurality of seed locations, the data structure that is associated with the seed location is a bitmap data structure.
